(19) United States
(12) Patent Application Publication
(10) Pub. No.: US 2026/0322206 A1
(43) Pub. Date: Oct. 15, 2026

(54) POTHEAD CONNECTIONS IN ESP MOTORS

(71) Applicant: Halliburton Energy Services, Inc., Houston, TX (US)

(72) Inventors: Philip John Ekins, Frimley (GB); Andras Bencze, Frimley (GB)

(21) Appl. No.: 19/179,302

(22) Filed: Apr. 15, 2025

(51) Int. Cl. H02K 5/22; E21B 17/02; E21B 43/12; F04D 13/10; H02K 5/10; H02K 5/132; H02K 7/14

(52) U.S. Cl. CPC H02K 5/225; E21B 17/028; F04D 13/10; H02K 5/10; H02K 5/132; H02K 7/14; E21B 43/128

(57) ABSTRACT

Disclosed embodiments relate generally to improved electrical connection systems and methods for ESP motors, and may relate more specifically to improved insulation approaches for pothead connections to the motor. For example, a discrete insulating sleeve can be threaded onto the corresponding pin or socket of the pothead. The socket or pin of a corresponding lead-out wire of the motor can be inserted into the sleeve and electrically coupled to the corresponding pin or socket of the pothead. An insulating nut disposed on the motor lead-out wire can be threaded onto the corresponding insulating sleeve. Similar connections can be made for all phases of the motor, for example each having a pin-socket connection within the corresponding insulating sleeve, and insulated without the use of the tape-in method.

### CROSS-REFERENCE TO RELATED APPLICATIONS

None.

### STATEMENT REGARDING FEDERALLY SPONSORED RESEARCH OR DEVELOPMENT

Not applicable.

### FIELD

This disclosure relates generally to the field of pumping. More particularly, this disclosure relates to the field of electric submersible pumps for use downhole in a well. Still more particularly, this disclosure relates to electrical connections for downhole motors of the sort which may be used in electric submersible pumps.

### BACKGROUND

Electric submersible pump (ESP) assemblies are used to artificially lift fluid to the surface, for example in deep wells such as oil or water wells. ESP assemblies are commonly used in the oil and gas industry to extract fluids from underground reservoirs. By way of example, the artificial lift provided by ESP assemblies may be useful in situations when the reservoir does not have sufficient pressure to allow the well to naturally produce, or when an additional boost to production of the well is desired. Improvements to ESP assemblies can improve overall production of fluids from a well, which may thereby improve the profitability of the well. Improvements in the construction and assembly of the ESP and/or its component parts may result in lower ESP costs and/or in improved characteristics (such as durability or run life or energy use).

A typical ESP assembly comprises, from bottom to top, a sensor unit, an electric motor, a seal unit, a pump intake, and a pump (e.g. typically a centrifugal pump), which are all mechanically connected together with shafts and shaft couplings. The electric motor supplies torque to the shafts, which provide power to the pump. The electric motor is isolated from a wellbore environment by a housing and by the seal unit. In some embodiments, the seal unit can act as an oil reservoir for the electric motor. For example, the oil can function both as a dielectric fluid and as a lubricant in the electric motor. The seal unit also may provide pressure equalization between the electric motor and the wellbore environment.

The pump is configured to transform mechanical torque received from the electric motor via a drive shaft to fluid pressure which can lift fluid up the wellbore. For example, a centrifugal pump typically has rotatable impellers within stationary diffusers. A shaft extending through the centrifugal pump is operatively coupled to the motor, and the impellers of the centrifugal pump are rotationally coupled to the shaft. In use, the motor can rotate the shaft, which in turn can rotate the impellers of the centrifugal pump relative to and within the stationary diffusers, thereby imparting pressure to the fluid within the centrifugal pump. The electric motor of the ESP is generally connected to a power source located at the surface of the well, for example using a cable and a motor lead extension. The ESP assembly can be placed into the well and usually is disposed inside a well casing. In a cased completion, the well casing separates the ESP assembly from the surrounding formation. In operation, perforations in the well casing can allow well fluid to enter the well casing and flow to the pump intake for transport to the surface. Disclosed embodiments relate to improved electrical connection of the ESP motor to the surface power source and related methods.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a schematic illustration of an exemplary electric submersible pump (ESP) assembly disposed in a wellbore, according to an embodiment of the disclosure;

FIG. 2 is a cross-sectional view of an exemplary motor for the electric submersible pump assembly of FIG. 1, according to an embodiment;

FIG. 3 is an exploded isometric view of the motor of FIG. 2, according to an embodiment of the disclosure;

FIG. 4 is a partial cut-away isometric view of an exemplary ESP motor having a plurality of rotor modules with rotor bearing assemblies therebetween, according to an embodiment of the disclosure;

FIG. 5 is an isometric view of an exemplary ESP motor of an ESP pump assembly, showing an exemplary pothead connection of the surface power source to the motor, according to an embodiment of the disclosure;

FIG. 6 is an exploded isometric view of an exemplary pothead connection system (e.g. showing the pothead connection prior to assembly on-site at the well), according to an embodiment of the disclosure;

FIG. 6A is a cross-section view illustrating an exemplary insulated sleeve of the sort that can be used in the pothead connection system of FIG. 6, according to an embodiment of the disclosure;

FIG. 7A is an isometric view of the exemplary pothead connection system of FIG. 6 at a first stage of assembly (e.g. with the insulated sleeves attached to the corresponding pins of the pothead), according to an embodiment of the disclosure;

FIG. 7B is a cross-section view of the pothead connection system of FIG. 7A, according to an embodiment of the disclosure;

FIG. 8A is an isometric view of the pothead connection system of FIG. 6 at a second stage of assembly (e.g. after the first stage of FIG. 7A, with the sockets of the motor lead-out wires inserted into the corresponding sleeve and engaged with the corresponding pin of the pothead), according to an embodiment of the disclosure;

FIG. 8B is a cross-section view of the pothead connection system of FIG. 8A, according to an embodiment of the disclosure;

FIG. 9A is an isometric view of the pothead connection system of FIG. 6 at a third stage of assembly (e.g. after the second stage of FIG. 8A, with the insulated nuts coupled to the corresponding sleeve), according to an embodiment of the disclosure;

FIG. 9B is a cross-section view of the pothead connection system of FIG. 9A, according to an embodiment of the disclosure;

FIG. 10 is an exploded isometric view of another exemplary pothead connection system (e.g. showing the pothead connection prior to assembly on-site at the well), according to an embodiment of the disclosure;

FIG. 11 is a cross-section view of the exemplary pothead connection system of FIG. 10 at a first stage of assembly (e.g. with the insulated sleeves attached to the corresponding pins of the pothead), according to an embodiment of the disclosure; and

FIG. 12 is a cross-section view of the pothead connection system of FIG. 10 at a third (e.g. final) stage of assembly (e.g. with assembly complete and/or with the electrical connection fully made-up, for example with the insulated nut coupled to the corresponding sleeve), according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

As used herein, orientation terms “upstream,” “downstream,” “up,” and “down” are defined relative to the direction of flow of well fluid in the well casing. “Upstream” is directed counter to the direction of flow of well fluid, towards the source of well fluid (e.g., towards perforations in well casing through which hydrocarbons flow out of a subterranean formation and into the casing). “Downstream” is directed in the direction of flow of well fluid, away from the source of well fluid. “Down” is directed counter to the direction of flow of well fluid, towards the source of well fluid. “Up” is directed in the direction of flow of well fluid, away from the source of well fluid.

Also as used herein, “electrically coupled” means that two or more components/elements have communicating internal conductive pathways through which electricity, if present, can flow. While a first component and a second component can be directly electrically coupled, in some embodiments the first component and the second component may be “electrically coupled” via a third component located between the first component and the second component (e.g. if the first component has conductive pathway(s) that communicates with conductive pathway(s) of the third component, and if the same conductive pathway(s) of the third component communicates with conductive pathway(s) of the second component). Electrically coupled components can provide signal communication, electrical power (e.g., voltage, power, capacity, etc.), or both.

Disclosed embodiments can relate generally to an electrical connection system for an ESP configured for downhole (e.g. deployed in a wellbore) use. Exemplary embodiments may comprise: a pothead; one or more (e.g. typically a plurality of) motor lead-out wires/lines (e.g. stator leads) coupled to and/or in electrical communication with (e.g. a motor of) the ESP (e.g. the stator of the ESP motor); and a discrete (e.g. separate) insulating sleeve corresponding to each lead-out wire and/or pothead connection (e.g. pin or socket of the pothead). Typically, each lead-out wire is electrically coupled to (e.g. soldered and/or crimped to) one of a pin or a connecting socket (e.g. corresponding to and/or configured to electrically engage with the pin); the pothead comprises a corresponding other of the pin or the socket, with each corresponding pin-socket set being configured for electrical connection/coupling when engaged (e.g. wherein each pin is configured for electrical connection to the corresponding socket (e.g. by plug-in engagement, with the pin being received within the socket)); each pin or socket of the pothead comprises threading (e.g. located externally on its base); for each lead-out wire, a nut is disposed on the corresponding lead-out wire, with the nut comprises threading (e.g. with the nut oriented with the threading towards the corresponding pin or socket coupled to the lead-out wire); each insulating sleeve comprises a first end configured for engagement with (e.g. configured to receive) one of the pin or the socket of the pothead, and a second end (e.g. opposite the first end) configured for engagement with (e.g. configured to receive) the other of the pin or the socket (e.g. of the lead-out wire); the second end of each insulating sleeve comprises distal internal threading corresponding to the threading of the corresponding nut (e.g. the distal internal threading is disposed in proximity to the second end) (e.g. the second end is configured to mesh via screwing for engagement with the threading of the corresponding nut, for example to mechanically retain the corresponding pin-socket connection within the sleeve); and the insulating sleeve further comprises internal pothead-retaining threading corresponding to the threading of the pin or socket of the pothead (e.g. configured for meshing attachment via screwing for engagement of the sleeve with the threading of the corresponding pin or socket of the pothead, for example to mechanically retain the sleeve onto the corresponding pin or socket of the pothead).

Typically, the internal pothead-retaining threading can be spaced from both the first end and the second end (e.g. disposed between the first and second ends). Typically, there may be only a single sleeve per pin-socket connection, and the sleeve can be configured to span and to effectively insulate the corresponding pin-socket connection (e.g. engagement of the pin and corresponding socket). Typically, the nut for each lead-out wire may be insulating. Typically, no insulating tape may be used for the pin-socket connection, for example with the insulating sleeve providing the only insulation for the connection.

In embodiments, a pothead extension portion of the sleeve can extend axially away from the pothead-retaining internal threading to the first end (e.g. with the pothead-retaining internal threading disposed on its interior surface away from proximity with the first or second end and/or on its interior surface in proximity to the transition between a wire connection portion and the pothead extension portion of the sleeve). In embodiments, a wire connection portion of the sleeve can extend axially from the pothead-retaining internal threading to the second end (e.g. with the distal internal threading corresponding to the threading of the corresponding nut). Typically, the pothead extension portion can be configured to extend into a body of the pothead, for example beyond the base of the corresponding pin or socket of the pothead, and to contact a stop mechanism within the body of the pothead (e.g. when threadingly coupled to the corresponding pin or socket of the pothead).

In some embodiments, the pothead extension portion may have a smaller inner diameter than the wire connection portion (e.g. the first end of the sleeve can have a smaller diameter than the second end of the sleeve). In some embodiments, the wire connection portion may have an axial length at least as great (e.g. typically greater, for example by the amount of threading) as the corresponding pin or socket of the corresponding lead-out wire (e.g. received therein). Typically, the sleeve can effectively insulate the pin-socket connection without the need for any insulating taping (e.g. the sleeve alone is sufficient for effective insulation, and there is no insulator tape wrapping of each pin-socket connection or of a plurality of connections together).

In some embodiments, the distal internal threading may not sealingly mesh with the threading of the corresponding nut (e.g. fluid, such as air and/or oil, may be able to pass through the threading mesh). In some embodiments, engagement of the pin and the corresponding socket may occur within the sleeve (e.g. formation of the pin-socket connection occurs within the sleeve). The pothead may also comprise a stop mechanism (e.g. an internal disc) configured for contact with the first end of the sleeve and/or configured to locate the first end of the sleeve axially within the body of the pothead (e.g. by contact). For example, the first end of the sleeve may be configured to contact the stop mechanism when threadingly engaged to the corresponding pin or socket of the pothead (e.g. with the stop mechanism, positively locating the sleeve axially within the body of the pothead when the pothead-retaining threads mesh with the threading of the corresponding pin or socket of the pothead).

In embodiments, a void can be formed between the pin-socket connection and the corresponding sleeve (e.g. with the sleeve encompassing the pin-socket connection and/or with the pin-socket connection disposed entirely within the corresponding sleeve). For example, the void can be configured to vent between the corresponding nut and the corresponding lead-out wire and/or between/through the threading connection of the nut to the second end of the sleeve (e.g. to the distal internal threading). In some embodiments, the void can extend axially between the stop mechanism and the insulating nut. In some embodiments, the threading connection of the nut to the second end of the sleeve may not be sealed (e.g. not a sealed connection) and/or the nut may not be sealingly coupled to and/or located on the corresponding lead-out wire (e.g. providing venting therethrough). Typically, oil (e.g. dielectric oil) can fill the void and/or there is no air trapped in the void (e.g. during motor usage).

By way of example, the sleeves in some embodiments can be threaded onto the electrical contacts of the pothead (e.g. one of the pin or socket) up to a hard stop, so that sleeve position within the pothead and motor head envelope may be more predictable and consistent from one installation to the next (e.g. compared to insulation installed by taping). By using such sleeves, insulation thicknesses, gaps, and tracking lengths can be known rather than approximated and/or may not depend on operator variability. Once the electrical connection has been made (e.g. between pin and corresponding socket), the pin-socket joint/connection can be held together with a nut engaged with the sleeve, for example to provide compression and resist loosening due to vibration. The looser arrangement of insulation material around the conductors (e.g. provided by such insulating sleeves) can reduce the chance of local air entrapment and/or promote the filling of voids (e.g. between the sleeve and the pin-socket connection) with dielectric oil (for example during the servicing phase of installation).

In some embodiments, the connectors for the pothead can be pins, while the connectors on the lead-out wires can be sockets. For example, some disclosed embodiments can replace the insulation tape of conventional systems with discrete insulating sleeves (e.g. which can comprise PEEK or TORLON or PTFE or ceramic or any electrically insulating organic or non-organic material) that attach to the connector pins of the pothead with a threaded detail. When the insulating sleeve is attached to (e.g. threaded onto) the corresponding pin of the pothead (e.g. using the internal pothead-retaining threading), the sleeve can positively locate on a stop mechanism within the pothead (e.g. an internal disc that is clamped within the body of the pothead), thereby locating the insulating sleeve in a consistent and repeatable position. In embodiments, an insulating nut can be pre-assembled onto the motor's lead-out wire, and a connector socket can then be attached to the lead-out wire. To make the electrical connection, the connector socket on the lead-out wire can be inserted into the insulated sleeve and engaged with the connector pin. Then, the thread on the nut can be engaged with a threaded end portion (e.g. distal internal threading) of the sleeve and tightened, thereby mechanically securing the electrical connection. This can be done for all lead-out wires (e.g. all phases of the motor). Once all three phases are connected, the insulated connections can be installed into the motor head housing, and the pothead can be secured (e.g. affixed to the motor head housing).

Typically, there would be no additional wrapping of tape around all three phases when such insulating sleeves are used (e.g. typically there is no need for additional wrapping of tape around all three phases, and the insulating sleeves alone may be sufficient). Advantageously, being discrete components, it can be possible to test the sleeves and nuts electrically, physically and/or mechanically prior usage, so that their performance may be verified. This can lead to higher confidence in the system's performance. Additionally, usage and component performance may be traced through the motor build and installation process. It may also be possible to dismantle the connection quickly and to re-use the components without affecting the quality of the insulation. Radial gaps between the motor lead-out wires and the nuts can be configured to vent the void space between the sleeve and the connector socket, which can allow this void space to be filled with dielectric oil during the motor's servicing. Filling these gaps/voids (that may otherwise contain air) with oil may reduce the chance of excessive heat build-up and subsequent damage to the wiring.

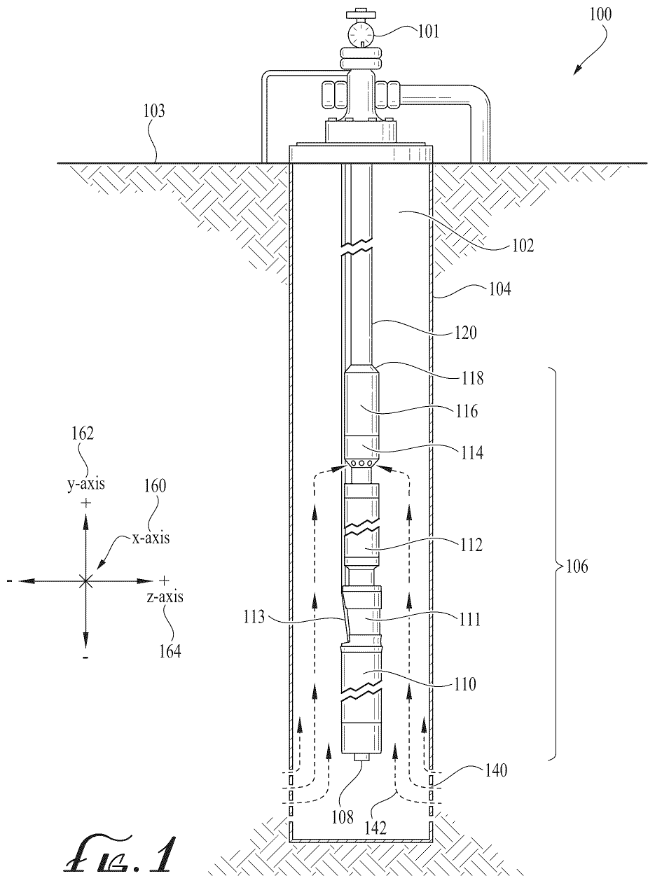

Turning now to FIG. 1, an exemplary producing well environment 100 is described. In an embodiment, the environment 100 comprises a wellhead 101 above a wellbore 102 located at the surface 103. A casing 104 is provided within the wellbore 102. For convenience of reference, FIG. 1 provides a directional reference comprising three coordinate axes—an X-axis 160 where positive displacements along the X-axis 160 are directed into the sheet and negative displacements along the X-axis 160 are directed out of the sheet; a Y-axis 162 where positive displacements along the Y-axis 162 are directed upwards on the sheet and negative displacements along the Y-axis 162 are directed downwards on the sheet; and a Z-axis 164 where positive displacements along the Z-axis 164 are directed rightwards on the sheet and negative displacements along the Z-axis 164 are directed leftwards on the sheet. In the embodiment of FIG. 1, the Y-axis 162 is approximately parallel to a central axis of a vertical portion of the wellbore 102.

An exemplary electric submersible pump (ESP) assembly 106 is deployed downhole in a well within the casing 104 and comprises an optional sensor unit 108, an electric motor 110 which may include a motor head 111, a seal unit 112, an electric power cable 113, a pump intake 114, a centrifugal pump 116, and a pump discharge 118 that couples the centrifugal pump 116 to a production tubing 120. The centrifugal pump 116 is operatively coupled to the motor 110 by a shaft (not shown). The electric motor 110 may be energized from the surface via the power cable 113 to produce the required torque to drive the pump 116 and produce fluid to the surface. The motor head 111 couples the electric motor 110 to the seal unit 112. The electric power cable 113 may connect to a source of electric power at the surface 103 and to the electric motor 110, for example being configured to provide power from the source of electric power at the surface 103 to the electric motor 110. In some implementations, the power cable 113 may be configured to convey data to and from the equipment at the surface and the ESP system (e.g. the motor), in addition to supplying power to the motor 110. In some implementations, the data may comprise one or more control or operational instructions, for example transmitted via a controller to which the power cable 113 may be communicatively coupled.

In operation, the casing 104 is pierced by perforations 140, and reservoir fluid 142 flows through the perforations 140 into the wellbore 102. The fluid 142 flows downstream in an annulus formed between the casing 104 and the ESP assembly 106, is drawn into the pump intake 114, is pumped by the centrifugal pump 116, and is lifted through the production tubing 120 to the wellhead 101 to be produced at the surface 103. The fluid 142 may comprise hydrocarbons such as oil and/or gas, water, or both hydrocarbons and water.

While the example illustrated in FIG. 1 relates to land-based subterranean wells, similar ESP systems can be used in a subsea environment and/or may be used in subterranean environments located on offshore platforms, drill ships, semi-submersibles, drilling barges, etc. And while the wellbore is shown in FIG. 1 as being approximately vertical, in other embodiments, the wellbore may be horizontal, deviated, or any other type of well. Also, while the pump of the ESP is described with respect to FIG. 1 as a centrifugal pump, other types of pumps (e.g. a progressive cavity pump, any other type of pump suitable for the system, or combinations thereof) may be used instead.

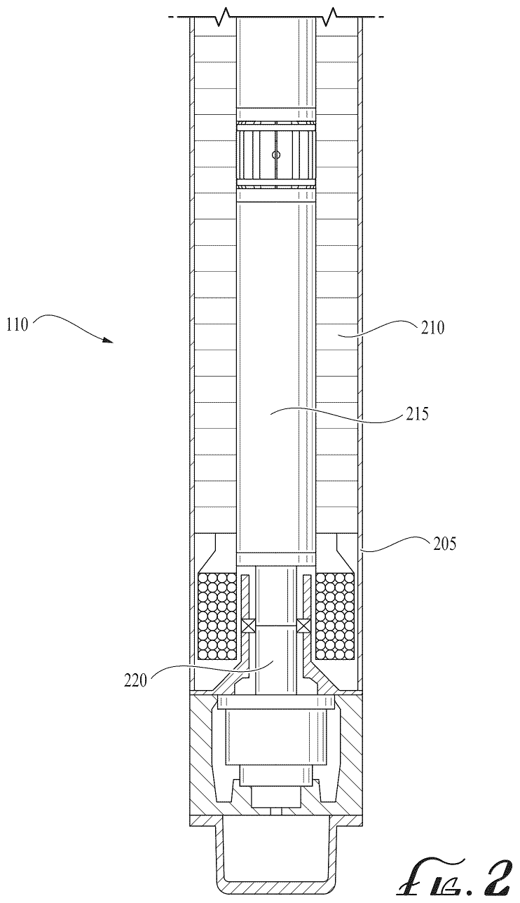

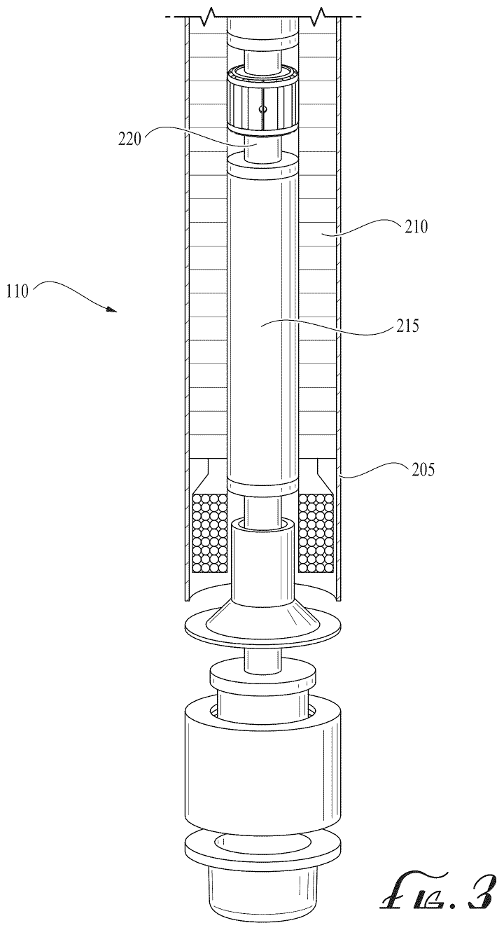

As shown in FIGS. 2-3, an exemplary motor 110 of the ESP assembly includes a housing 205, a stator 210, a rotor 215 (which may in some embodiments be a rotor assembly), and a drive shaft 220. The housing 205 typically comprises a hollow cylinder or tube and is configured to protect the internal components of the motor 110 from the external environment. The stator 210 also typically comprises a hollow cylinder and is secured to the housing 205 (e.g. to the inner surface of the housing 205) so as to be stationary within the housing 205. Typically, the stator 210 comprises a plurality of laminations, which may be thin sheets of electrical steel, wrapped by a plurality of electrically conductive windings. When energized (e.g. by power supplied from the surface, for example via lead-out lines and/or through a pothead connection), the windings can generate a rotating magnetic field for interaction with the rotor 215 to induce rotation of the rotor 215. The rotor 215 also typically comprises a hollow cylinder and is concentrically arranged between the stator 210 and the drive shaft 220, for example with the drive shaft 220 typically extending longitudinally along the centerline of the motor 110, the rotor 215 disposed around the drive shaft 220, and the stator 210 disposed around the rotor 215, within the housing 205. The rotor 215 is rotatable within the stator 210 and secured to the drive shaft 220, such that rotation of the rotor 215 drives the drive shaft 220. In embodiments, the motor 110 may be a two or more pole motor, a three-phase squirrel cage induction motor, a permanent magnet motor (PMM), a hybrid PMM, or other motor configuration.

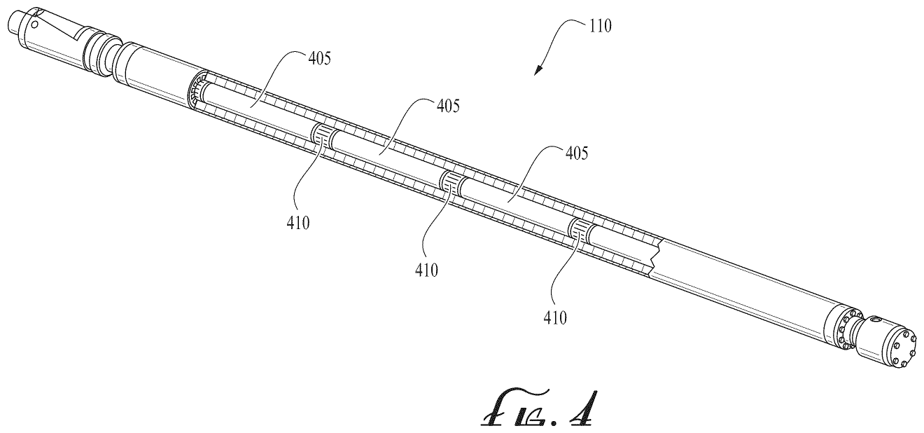

Depending on the power requirements of the motor 110, the rotor 215 can be an assembly which typically includes a number of rotor modules, which together jointly form the rotor assembly 215, with each rotor module secured to the drive shaft 220. The rotational magnetic field of the stator 210 when energized can induce rotation of the rotor 215, and thereby the drive shaft 220, with the drive shaft 220 transmitting rotational torque from the motor 110 to the pump 116. As shown in FIG. 4, the rotor modules 405 (jointly forming the rotor 215) are typically spaced apart from each other along the drive shaft 220, with a rotor bearing assembly 410 typically located between adjacent rotor modules 405. Rotor bearing assemblies 410 can also be located at the top of the uppermost rotor module 405 and/or the bottom of the lowermost rotor module 405 (e.g. at the top and bottom of the rotor). In some embodiments, the rotor bearing assembly 410 can be a hydrodynamic bearing assembly. Each rotor bearing assembly 410 is configured to support the rotor 215 at predefined axial positions to maintain correct radial alignment of the drive shaft 220 during motor operation.

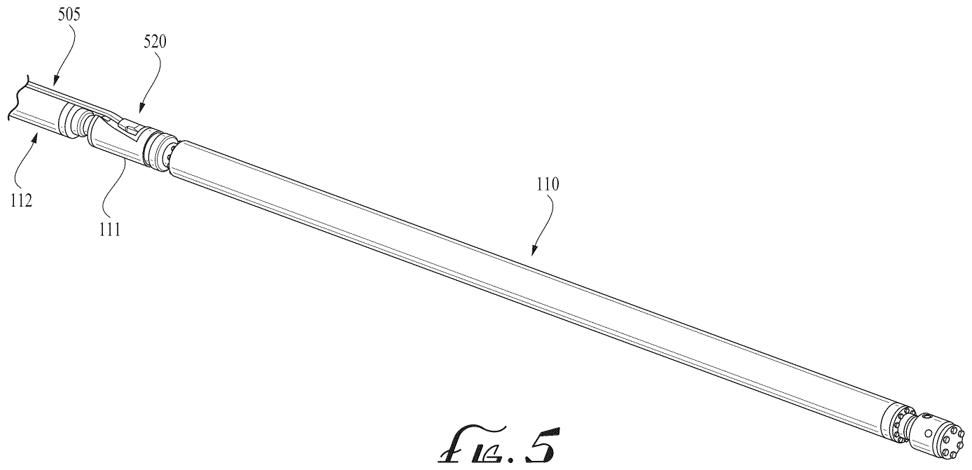

So in order to operate, power from the surface must energize the stator. Typically, the power cable from the surface can be connected to the motor (which may be a three-phase AC type motor in some embodiments) through a pothead connection. FIG. 5 illustrates an exemplary pothead 520 coupled to a motor head 111 of an exemplary ESP motor 110. In FIG. 5, the motor lead extension 505 enters the pothead, and can be electrically coupled to the power cable from the surface power source. For example, the power cable may be spliced to a motor lead extension 505 (also known as a motor extension or MLE), which can enter into the pothead 520. The MLE 505 may comprise a flat cable, which can terminate into the pothead connector 520, which typically may have male electrical pins. This type of connector may be referred to as a pothead. Typical pothead 520 embodiments may be configured for the pins to each electrically couple to a female receptacle (e.g. a socket) associated with the motor head.

For example, the pothead 520 can be electrically connected to the stator via lead-out lines/wires (as discussed herein and shown in figures discussed below). In embodiments, the pothead 520 can form a seal with the housing of the motor section to prevent harmful wellbore fluids and/or gases from entering into the motor section. In embodiments, the pothead 520 can also form a seal to the stator leads (e.g. lead-out lines) to prevent the ingress of wellbore fluids via the cable connection. Although some exemplary illustrations may show only one cable/wire/line (e.g. power cable and motor lead), it is understood that the power cable and motor lead can comprise multiple single cables referred to as phases. For example, a motor lead can typically comprise three phases or leads that can couple with the stator leads (e.g. lead-out wires) of a three-phase electric motor. So, the pothead 520 can be configured to provide electrical connection for each phase or lead of the power cable, the motor lead, and/or the lead-out wires/lines. For example, three connections can be made for a typical three phase motor to couple the three phases of the power cable or motor lead to the stator (e.g. lead-out wires).

Typically, such electrical connection can be by pin and socket connections, which require an appropriate level of insulation from the adjacent body of the equipment. Often, the pin and socket connections would be insulated on site by personnel using insulating tape (e.g. a process known as “tape-in”, in which the personnel on site repeatedly wrap insulating tape around each pin-socket connection in a manner that arc gaps and tracking distances are managed to provide the level of electrical isolation required for the system's operating voltages). For example, the insulating tape can comprise an insulating material, such as virgin PTFE tape. The insulating tape can be manually wrapped in a spiral pattern of overlapping tape on site, to insulate each pin-socket connection. In addition to wrapping each specific connection, all of the connections (e.g. for the various motor phases) may also be wrapped together using the same insulating tape. This process typically is done manually on-site during ESP installation, often in difficult environments that can affect repeatability, quality, and eventual performance of the system.

Taping-in electrical connections of the pothead to motor head interface can be a time-consuming process that demands a highly skilled operator to be performed successfully and/or repeatedly, so that required electrical insulation levels are achieved. Unfortunately, during tape-in the success of this operation cannot be established until the taping process is complete. For example, the measure of success can be established by exposing the conductors to a test voltage and measuring the leakage current through the insulation to the surrounding metalwork, thereby determining the insulation resistance. Typically during tape-in, each phase connection can be individually wrapped with insulating tape, and then wrapped as a whole. There are usually minimum tape overlap and layer requirements to be satisfied when wrapping in this manner.

Tightly wrapping the insulated tape may also have the undesired effect of trapping small amounts of air that will not be fully evacuated from within the motor during its servicing (e.g. with dielectric oil) in readiness to operate. Unfortunately, any air remaining around the connections may affect the dispersal of any heat that is produced by the action of electrical current passing from one side of the electrical connection to the other, due to contact surface resistance. Excessive temperature rises and ultimately, the failure of the connection, are often observed as a result. Disclosed embodiments relate to improved systems and methods of providing electrical connection between the pothead and the ESP motor, and specifically may provide improvements in connection insulation and methods of installing same. Such improvements may mitigate one or more of the concerns arising from the tape-in process, as persons of skill may appreciate based on this disclosure.

Disclosed embodiments can replace the manually installed insulation tape with discrete insulating sleeves that can be designed to meet the insulation performance requirements while addressing the repeatability and accuracy limitations of such tape being applied by different personnel with differing skill of application, under different conditions, and/or at different locations. Being discrete components, it is possible to test the sleeves electrically, physically and/or mechanically prior to usage (e.g. offsite and/or during manufacture), so that their performance may be verified (e.g. leading to higher confidence in the system's performance).

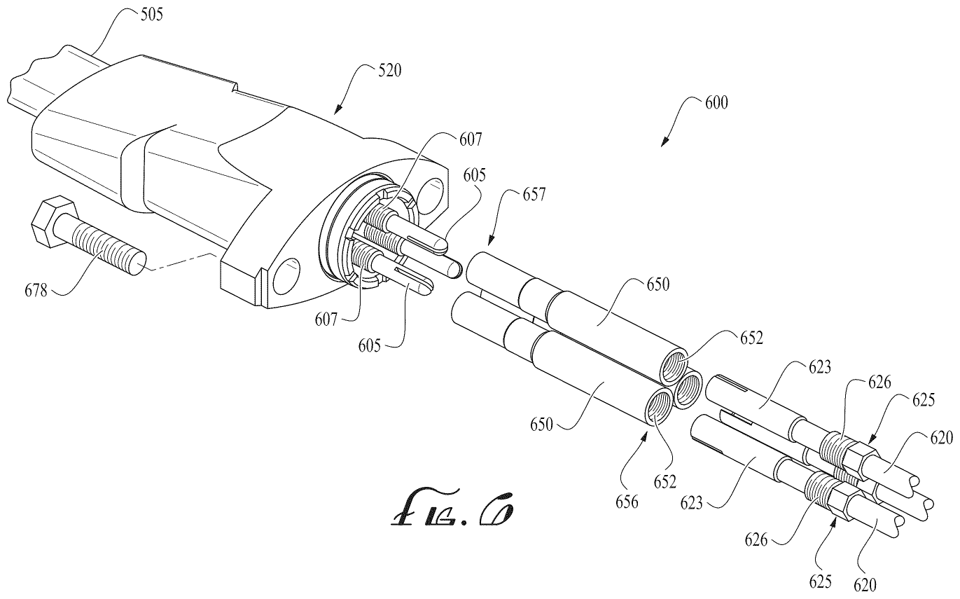

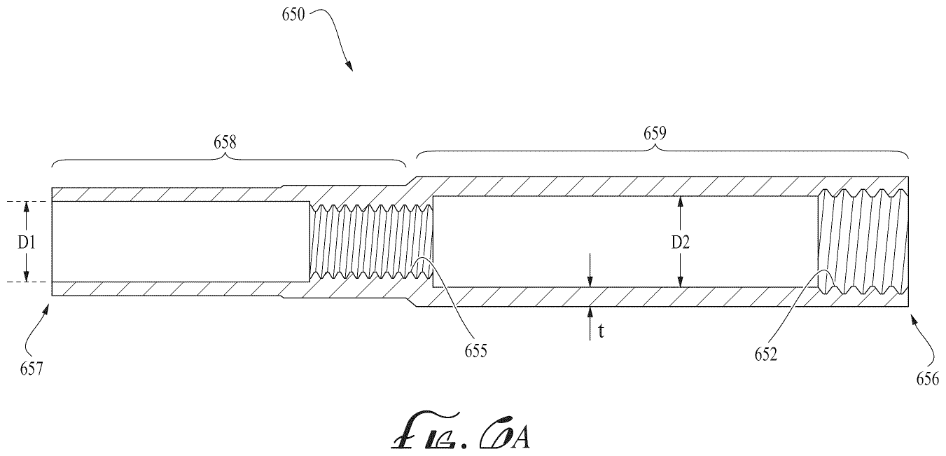

FIG. 6 illustrates an exemplary pothead connection system 600 (e.g. showing the pothead connection prior to assembly on-site at the well and illustrating the primary components of the system), according to an embodiment of the disclosure. For example, the system 600 of FIG. 6 may comprise a pothead 520; one or more (e.g. typically a plurality of) motor lead-out wires 620 (e.g. stator flexible extension leads) coupled to and/or in electrical communication with (e.g. a motor of) the ESP (e.g. the stator of the ESP motor); and an insulating sleeve 650 corresponding to each lead-out wire 620. In the embodiment of FIG. 6, each lead-out wire/line 620 can be electrically coupled to (e.g. soldered and/or crimped to) a connecting socket 623, and the pothead 520 can comprise a pin 605 corresponding to each socket 623 or lead-out wire 620. Each corresponding pin-socket set can be configured for electrical connection when engaged (e.g. with each pin 605 configured for electrical connection to the corresponding socket 623 (e.g. by plug-in/mating engagement). Each pin 605 of FIG. 6 can comprise threading 607, for example located externally on its base. For each socket 623, a nut 625 can be disposed on the corresponding motor lead-out wire 620, and the nut 625 can comprise threads 626 (e.g. with the nut oriented with the threads towards the socket 623). In some embodiments, the nut 625 can also be insulating, for example similar to the sleeve 650.

In FIG. 6, each insulating sleeve 650 can comprise a first end 657 configured for engagement with (e.g. configured to receive) the corresponding pin 605, and a second end 656 configured for engagement with (e.g. configured to receive) the corresponding socket 623. The second end 656 of each insulating sleeve can comprise internal threads corresponding to the threads 626 of the corresponding nut 625 (e.g. configured to mesh via screwing for engagement with the threads of the corresponding nut 625, for example to mechanically retain the corresponding socket 623 within the sleeve 650), which may be termed distal internal threading 652. The sleeve 650 of FIG. 6 can further comprise internal threading corresponding to the threading 607 of the corresponding pin 605 (e.g. configured for meshing attachment via screwing for engagement with the threads 607 of the corresponding pin 605, for example to mechanically retain the sleeve 650 onto the pin 605 and/or pothead 520), which may be termed internal pothead-retaining threading 655. In FIG. 6, the internal pothead-retaining threads 655 can be spaced from both the first end 657 and the second end 656 (see for example FIG. 6A, illustrating in greater detail the aspects of the insulating sleeve 650).

Typically, the pin 605 can have a generally cylindrical shape, for example with an outer surface and a tapered end. The pin connector 605 can be coupled to the MLE in a manner to allow the transmission of electrical power and/or signal from the pin 605 to the MLE and/or vice versa. For example, the pin connector 605 can be soldered, brazed, welded, crimped or threaded and crimped to the motor lead. Typically, the socket connector 623 can have a generally cylinder shape, for example with an outer surface and a receiving bore having an inner surface. In some embodiments, the socket connector 623 can include a number of slots extending from the outer surface to the receiving bore. The pin connector 605 can be installed into the receiving bore of the socket connector 623, for example with the outer surface of the pin 605 in direct contact with the inner surface of the socket 623 (e.g. when the pin 605 matingly engages in the socket 623, thereby electrically coupling the pin 605 and socket 623 via surface contact). In embodiments, the pin connector 605 can have an interference fit within the socket 623, e.g., the outer surface of the pin connector 605 can be larger than the inner surface of the bore of the socket connector 623. For example, the slots in the socket connector 623 can allow the bore of the socket connector to enlarge to accept the larger diameter of the outer surface of the pin connector 605. In embodiments, the pins 605 may be positioned in a precise location on a predefined pitch circle diameter within the pothead 520, for example such that all three phases are spaced evenly.

Typically, there may be only a single sleeve 650 per pin-socket connection, and the sleeve 650 can be configured to span and to effectively insulate the corresponding pin-socket connection (e.g. engagement of the pin 605 and corresponding socket 623). In FIG. 6, the internal pothead-retaining threading 655 (e.g. the threading corresponding to the pin 605) can be disposed between the first and second ends 657, 656 of the insulating sleeve 650, with a pothead extension portion 658 of the sleeve 650 extending axially away from the internal pothead-retaining threading 655 to the first end 657 (e.g. with the internal pothead-retaining threading 655 disposed on the sleeve's interior surface away from proximity with the first or second end and/or on the sleeve's interior surface in proximity to the transition between a wire connection portion 659 and the pothead extension portion 658).

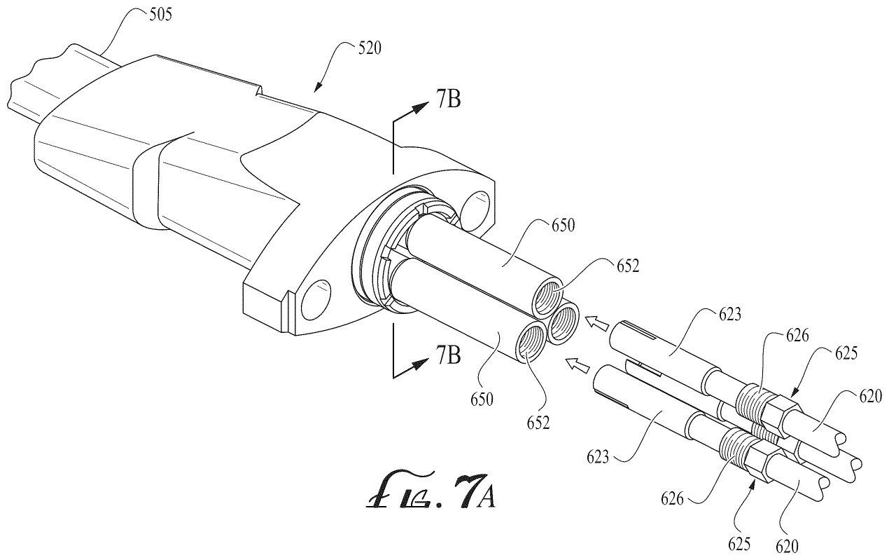

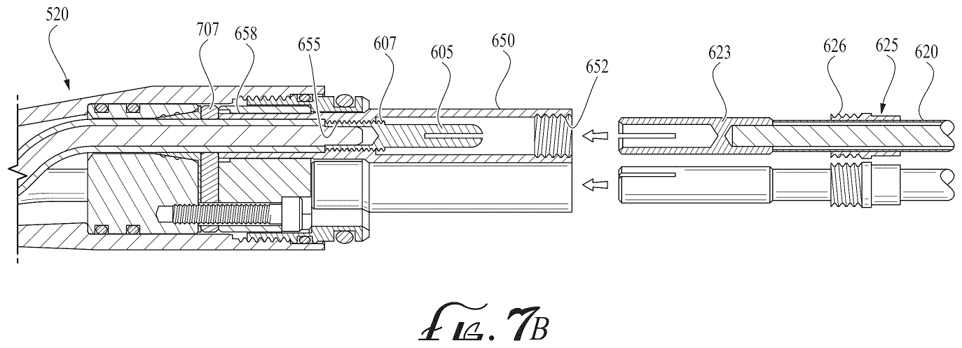

A wire connection portion 659 of the sleeve 650 can extend axially from the internal pothead-retaining threading 655 to the second end 656 (e.g. with the distal internal threading 652 disposed on the sleeve's interior surface in proximity to the second end 656). As shown in FIG. 7B, the pothead extension portion 658 can be configured to extend into a body of the pothead 520, beyond the base of the corresponding pin 605, and to contact a stop mechanism 707 (e.g. when the sleeve 650 is threadingly coupled to the corresponding pin 605). In some embodiments, the pothead extension portion 658 can have a smaller inner diameter than the wire connection portion 659 (e.g. the first end 657 of the sleeve can have a smaller diameter D1 than the second end 656 of the sleeve (D2)). In some embodiments, the wire connection portion 659 can have an axial length at least as great (e.g. typically greater, for example by the amount of threading) as the corresponding socket 623 (e.g. received therein). Typically, engagement of the pin 605 and the corresponding socket 623 can occur entirely within the insulating sleeve 650.

Typically, the sleeve 650 can effectively insulate the pin-socket connection without the need for any insulating taping (e.g. the sleeve 650 alone is sufficient for effective insulation of the electrical connection, and there is no taping of each pin-socket connection or of a plurality of connections together). In some embodiments, the distal internal threads 652 do not sealingly mesh with the threads 626 of the corresponding nut 625. The insulating nut 625 can be configured to secure the corresponding socket 623 within the corresponding sleeve 650, for example when threadingly engaged/secured with the second end 656 of the corresponding sleeve 650. For example, the nut 625 can be configured to abut the corresponding socket 623 (e.g. a shoulder of the socket), when threadingly engaged with the second end 656 of the corresponding sleeve 650 (e.g. with the socket 623 disposed within the corresponding sleeve 650), and/or the nut 625 can be configured to provide compression and/or to resist loosening (e.g. due to vibration, for example of the pin-socket connection). In the embodiment of FIG. 6, the insulating nut 625 can be free to rotate about the corresponding motor lead-out wire 620 and/or slidable on the corresponding motor lead-out wire 620.

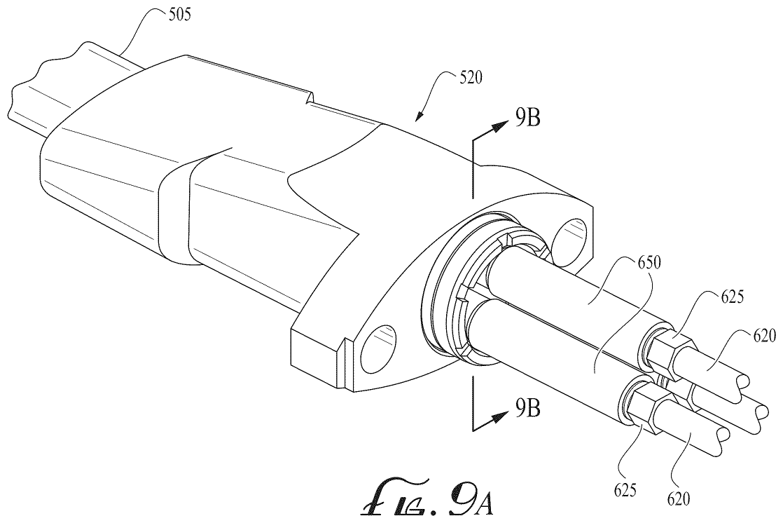

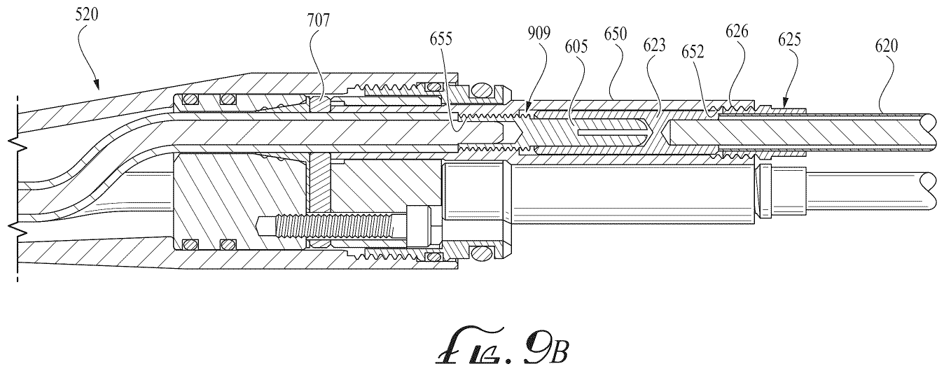

When installed, the insulating sleeve 650 can be coupled (e.g. by meshing thread attachment) to the corresponding pin 605 at the first end 657 and to the corresponding insulating nut 625 at the second end 656 (see for example, FIG. 9B). In embodiments, the pothead 520 can further comprise a stop mechanism 707 (e.g. an internal disc) configured for contact with the first end 657 of the sleeve 650 and/or configured to locate the first end 657 of the sleeve axially within the body of the pothead 520 (e.g. by contact). Thus, the first end 657 of the sleeve can contact the stop mechanism 707 when threadingly engaged to the corresponding pin 605, for example with the stop mechanism 707 positively locating the sleeve 650 axially within the body of the pothead 520 (see for example FIG. 7B).

Typically, a void 909 can be formed between the pin-socket (605-623) connection and the corresponding sleeve 650 (e.g. with the sleeve encompassing the pin-socket connection and/or with the pin-socket connection disposed entirely within the corresponding sleeve), and the void 909 can be configured to vent between the corresponding nut 625 and the corresponding lead-out wire 620 and/or between/through the threading connection of the nut 625 to the second end 656 of the sleeve 650 (e.g. to the distal internal threading 652). Typically, the void 909 can extend axially between the stop mechanism 707 and the insulating nut 625. See for example FIG. 9B, illustrating a fully made-up exemplary connection. In some embodiments, the threading connection of the nut 625 to the second end 656 of the sleeve 650 may not be sealed (e.g. not a sealed connection) and/or the nut 625 may not be sealingly coupled to and/or located on the corresponding lead-out wire 620, for example providing venting therethrough for the void 909. In embodiments, the stop mechanism 707 can contact a conical section seal 914 of the pothead 520 opposite the sleeve 650 (see for example FIG. 9B). Oil (e.g. dielectric oil) can fill the void 909 so that there is no air trapped in the void 909 (e.g. with oil entering the void 909 through the venting described above and air leaving therethrough).

While the insulating sleeve 650 typically is configured to effectively insulate the pin-socket connection, in some embodiments the sleeve 650 can have an insulating value of approximately 20 kV/mm (e.g. 500 Volts/mil), the sleeve 650 can have a wall thickness (t) of greater than 1 mm (e.g. 1.2-2 mm, 1-2 mm, or approximately 2 mm), and/or the sleeve 650 can have a length sufficient to entirely cover the pin-socket connection, such as a length of approximately 45-50 mm. In some embodiments, the pothead extension portion 658 can have a length of approximately 22.5-25 mm and/or the wire connection portion 659 can have a length of approximately 22.5-25 mm. In some embodiments, the sleeve 650 may comprise (e.g. be entirely formed of, for example as a single, unitary continuous cylindrical element) PEEK or TORLON or PTFE or ceramic or any electrically insulating organic or inorganic material. In some embodiments, the nut 625 may comprise PEEK or TORLON or PTFE or ceramic or any electrically insulating organic or inorganic material. In some embodiments, the sleeve 650 and nut 625 can comprise the same material.

In some embodiments, the threading (e.g. of the pin, nut, distal internal threading of the sleeve, and/or internal pothead-retaining threading of the sleeve) can comprise trapezoidal threads (e.g. of approximately 60 degrees). In some embodiments, the socket 623 can be pre-attached to the corresponding lead-out wire 620 (e.g. not attached on site, but pre-assembled). In some embodiments, the separate sleeve 650 for each pin-socket connection can be configured for installation over the connection at the site (e.g. while making up the pin-socket connection on-site). In some embodiments, the one or more lead-out wires 620 can comprise a plurality of lead-out wires (e.g. and corresponding pins, sockets, and nuts), which may correspond in number to the phases of the ESP motor (e.g. stator). For example, the plurality of motor lead-out wires 620 (e.g. and corresponding pins, sockets, and nuts) can comprise three (3) lead-out wires (e.g. and corresponding pins, sockets, and nuts). In some embodiments, the pothead 520 (e.g. its body) can further comprise an affixing mechanism 678 (e.g. corresponding bolts and holes as shown in FIG. 6) configured to secure the pothead 520 to the motor of the ESP (e.g. after the electrical connection/coupling of the corresponding pins and sockets have been made).

FIG. 6A is a cross-sectional view illustrating an exemplary insulated sleeve 650 of the sort that can be used in a pothead connection system (e.g. such as illustrated in FIG. 6), according to an embodiment of the disclosure. For example, the insulating sleeve 650 can comprise a hollow elongate body having a first end 657 configured for engagement with (e.g. configured to receive) the corresponding pin 605, and a second end 656 configured for engagement with (e.g. configured to receive) the corresponding socket 623. As shown in FIG. 6A, the hollow elongate body can have a bore therethrough, extending axially from the first end 657 to the second end 656. The first end 657 of the bore can be configured to receive the corresponding pin 605 of the pothead 520 and the second end 656 of the bore can be configured to receive the corresponding socket 623 of the ESP motor lead-out line 620.

The second end 656 of the hollow elongate body can comprise distal internal threading 652 (e.g. threading disposed on its internal surface) corresponding to the threading 626 of the corresponding nut 625 (e.g. configured to mesh via screwing for engagement with the threading of the corresponding nut, for example to mechanically retain the corresponding socket within the sleeve). Additionally, the hollow elongate body can further comprise internal pothead-retaining threading 655 (e.g. threading disposed on its internal surface and corresponding to the threading 607 of the corresponding pin 605 (e.g. configured for meshing attachment via screwing for engagement with the threading of the corresponding pin, for example to mechanically retain the sleeve onto the pin and/or pothead). In FIG. 6A, the internal pothead-retaining threading 655 can be spaced from both the first end 657 and the second end 656 (e.g. disposed between the first and second end of the sleeve). For example, the internal pothead-retaining threading 655 can be disposed between the first and second ends of the hollow elongate body, with a pothead extension portion 658 of the sleeve 650 extending axially away from the internal pothead-retaining threading 655 to the first end 657 (e.g. with the internal threading corresponding to the pin disposed on the sleeve's interior surface away from proximity with the first or second end and/or on the sleeve's interior surface in proximity to the transition between a wire connection portion 659 and the pothead extension portion 658).

A wire connection portion 659 of the sleeve 650 can extend axially from the internal pothead-retaining threading 655 to the second end 656. In FIG. 6A, the wire connection portion 659 can have a substantially constant bore diameter (e.g. along its axial length), and the pothead extension portion 658 can have a substantially constant bore diameter (e.g. along its axial length). In some embodiments, the bore diameter D1 of the pothead extension portion 658 may be less than the bore diameter D2 of the wire connection portion 659. In embodiments, the pothead extension portion 658 can be configured to extend into a body of the pothead 520, beyond a base of the corresponding pin 605, and to contact a stop mechanism 707. For example, the pothead extension portion 658 of the sleeve 650 may have a length of approximately 22.5-25 mm. In embodiments, the wire connection portion 659 can have an axial length at least as great (e.g. typically greater, for example by the amount of threading) as the corresponding socket 623 (e.g. received therein).

Typically, the hollow elongate body of the sleeve 650 can be configured to span and to effectively insulate the corresponding pin-socket connection 605-623. For example, the sleeve 650 can effectively insulate the pin-socket connection without the need for any insulating taping (e.g. the sleeve alone is sufficient for effective insulation, and there is no taping of each pin-socket connection or of a plurality of connections together). In embodiments, the body of the sleeve 650 can comprise a single (e.g. unitary) substantially cylindrical element (e.g. substantially symmetrical about its longitudinal centerline axis). For example, in some embodiments, the hollow elongate body, while substantially cylindrical, may have a different outer diameter for the wire connection portion 659 and the pothead extension portion 658 and/or may have a different inner/bore diameter for the wire connection portion 659 and the pothead extension portion 658 (although those two portions may be jointly formed as a unitary element in some embodiments). Typically, the sleeve 650 may be pre-formed (e.g. molded) off-site, for example as a unitary element (e.g. a single solid sleeve element). The sleeve 650 can be configured for assembly to insulate a pin-socket connection on-site, for example without tape and/or instead of tape-in.

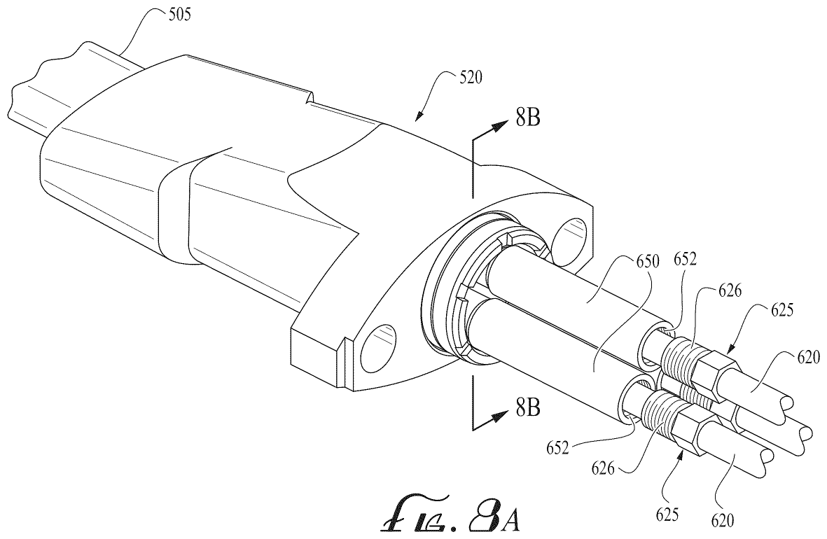

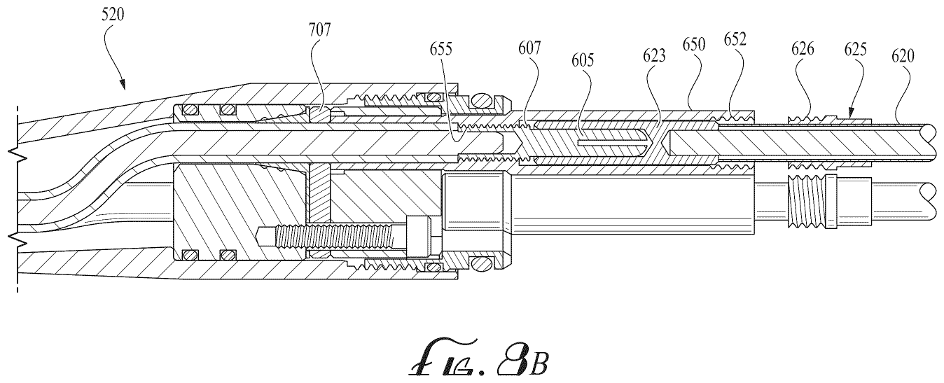

FIGS. 7A-9B illustrate the process of insulating the pin-socket connection and/or of making the pin-socket connection using the discrete insulating sleeve 650 (e.g. for the system illustrated in FIG. 6) and/or of using the disclosed embodiment of FIG. 6 to electrically connect the pothead 520 to the motor of the ESP. FIG. 7A is an isometric view of the exemplary pothead connection system of FIG. 6 at a first stage of assembly (e.g. with the insulated sleeves 650 attached to the corresponding pins 605 of the pothead 520), according to an embodiment of the disclosure. The first end 657 of the sleeve 650 can slide onto the pin 605, with the pothead extension portion 658 of the sleeve receiving the corresponding pin 605. The sleeve 650 can then be threaded/screwed onto the pin 605 (e.g. with the pothead-retaining threading 655 of the sleeve meshing with the threading 607 of the corresponding pin 605). The second end 656 of the sleeve 650 can then project outward from the pin 605. FIG. 7B is a cross-section view of the pothead connection system of FIG. 7A, according to an embodiment of the disclosure, and illustrates the internal component interaction after the sleeve 650 is threaded onto the corresponding pin 605. As can be seen in FIG. 7B, FIG. 8B, and FIG. 9B, the first end 657 of the sleeve 650 can contact the stop mechanism 707, positively locating the sleeve 650 within the pothead body 520.

FIG. 8A is an isometric view of the pothead connection system of FIG. 6 at a second stage of assembly (e.g. after the first stage of FIG. 7A, with the sockets 623 of the motor lead-out wires 620 then inserted into the corresponding sleeve 650 and engaged with the corresponding pin 605 of the pothead 520), according to an embodiment of the disclosure. As illustrated in FIGS. 8A-B, the corresponding socket 623 can be inserted into the second end 656 of the sleeve 650 (e.g. extending from the pin) and electrically coupled to the corresponding pin 605 (e.g. within the sleeve 605). FIG. 8B is a cross-section view of the pothead connection system of FIG. 8A, according to an embodiment of the disclosure, and illustrates the electrical coupling of the socket 623 to the pin 605 (e.g. with the pin 605 being received in the receiving bore of the socket 623).

FIG. 9A is an isometric view of the pothead connection system of FIG. 6 at a third stage of assembly (e.g. after the second stage of FIG. 8A, with the insulated nuts 625 then coupled to the corresponding sleeve 650), according to an embodiment of the disclosure. As illustrated in FIGS. 9A-B, the corresponding insulating nut 625 can then be threaded onto the second end 656 of the sleeve 650 (e.g. with the threading 626 of the nuts mating with the distal internal threading 652 of the sleeve 650). FIG. 9B is a cross-section view of the pothead connection system of FIG. 9A, according to an embodiment of the disclosure, and illustrates the finalized connection, with the pin-socket connection 605-623 securely held in the sleeve 650 and/or onto the pothead 520.

Taken as a whole, FIGS. 6, 7A, 8A, and 9A (and their accompanying cross-sections) illustrate an exemplary method of installing an ESP at a well (e.g. methods of electrically connecting a pothead to the lead-out wires of the ESP motor, including methods of insulating such pin-socket connections). For example, a method of installing an ESP at a well can comprise: providing (e.g. on-site at the wellsite) a pothead having a plurality of pins, each with threading; providing (e.g. on-site at the wellsite) an ESP having a motor with a plurality of lead-out wires (e.g. corresponding to the phases of the motor), each having a socket and an insulating nut, wherein the plurality of lead-out wires (e.g. sockets and nuts) is equal in number to the plurality of pins; providing (e.g. on-site at the wellsite) a plurality (e.g. corresponding to the number of led-out wires) of insulating sleeves; threading (e.g. on-site at the wellsite) each insulating sleeve onto the corresponding pin of the pothead; inserting (e.g. on-site at the wellsite) each socket into the corresponding sleeve; electrically connecting/engaging/coupling (e.g. on-site at the wellsite) each socket with the corresponding pin, wherein a corresponding pin-socket connection is disposed within the corresponding sleeve; and threading (e.g. on-site at the wellsite) each nut to the sleeve to retain the pin-socket connection within the sleeve. In some embodiments, threading each insulating sleeve onto the corresponding pin, inserting each socket into the corresponding sleeve, electrically connecting each socket with the corresponding pin, and/or threading each nut to the sleeve can occur on-site (e.g. at the wellsite).

In embodiments, the pothead, ESP, and insulating sleeve can be provided (e.g. transported to) on-site (e.g. at the wellsite) (for example so that connection of the pothead to the motor of the ESP can occur on-site). Typically, each sleeve can be initially (e.g. when provided on-site) separate and distinct from the corresponding pothead and/or the socket/lead wire/nut (e.g. sleeve is not integral and/or integrated). In some method embodiments, threading each insulating sleeve onto the corresponding pin can occur before electrically connecting/engaging each socket with the corresponding pin and/or before threading each nut to the sleeve (although in other embodiments, the nut could be threaded to the sleeve before the sleeve is threaded to the corresponding pin and/or electrically connecting/engaging each socket with the corresponding pin could occur before threading the sleeve onto the corresponding pin, for example with the socket first being inserted though the sleeve).

Typically, each socket can be configured to electrically connect/engage/couple with the corresponding pin. As shown in FIGS. 7A-9B, each sleeve can comprise threading configured for meshing attachment to the threading of the corresponding pin and each sleeve can comprise threading configured for meshing attachment to the threading of the corresponding nut. For example, the threading (e.g. distal internal threading) configured for meshing attachment to the threading of the corresponding nut can be disposed at an end (e.g. the second end) of the sleeve (e.g. on its internal surface), and the threading (e.g. internal pothead-retaining threading) configured for meshing attachment to the threading of the corresponding pin can be disposed between ends of the sleeve. In embodiments, a wire connection portion of the sleeve can extend axially from the threading (e.g. internal pothead-retaining threading) configured for meshing attachment to the corresponding pin toward the end of the sleeve with the threading (e.g. distal internal threading) configured for meshing attachment to the corresponding nut, and a pothead extension portion of the sleeve can extend axially away from the threading (e.g. internal pothead-retaining threading) configured for meshing attachment to the corresponding pin toward an opposite end of the sleeve (e.g. opposite the end of the sleeve having the threading configured for meshing attachment to the corresponding nut). The pothead extension portion of the sleeve can be configured to extend into a body of the pothead, beyond a base of the corresponding pin, and to contact a stop mechanism (e.g. when threadingly coupled to the corresponding pin).

In embodiments, threading each insulating sleeve onto the corresponding pin can comprise disposing a pothead extension portion of the sleeve within a body of the pothead, with the pothead extension portion extending (e.g. axially) into the body of the pothead beyond the pin. In embodiments, inserting each socket into the corresponding sleeve can comprise inserting each socket into a wire connection portion of the sleeve. Threading the sleeve onto the pin, inserting the socket into the sleeve, electrically connecting the socket with the pin, and threading the nut to the sleeve can occur at the wellsite (e.g. in the field and/or in proximity to the well). In embodiments, electrically connecting each socket with the corresponding pin can occur within the corresponding sleeve (e.g. engagement occurs within the corresponding sleeve).

In some embodiments, threading each insulating sleeve onto the corresponding pin can comprise threading the sleeve until the sleeve contacts a stop mechanism (e.g. internal disc) within a body of the pothead (configured to provide a hard stop for assembly of the sleeve onto the pothead). For example, threading the sleeve until the sleeve contacts a stop mechanism can comprise inserting the pothead extension portion of the sleeve into the body of the pothead until it contacts the stop mechanism) and/or positively locating each sleeve within the pothead (e.g. by contacting the stop mechanism). In embodiments, threading each nut to the sleeve can comprise threading the nut until it abuts the socket disposed in the sleeve (e.g. abuts a shoulder of the socket).

In embodiments, electrically connecting/engaging/coupling each socket with the corresponding pin within the corresponding sleeve can further comprise insulating the pin-socket connection (e.g. with the sleeve). In the embodiments of FIGS. 7A-9B, insulating the pin-socket connection can occur without any taping (e.g. no use of insulating tape) (e.g. no tape-in of the pin-socket connection on site). For example, insulating the pin-socket connection may use only the corresponding sleeve for insulation (e.g. only a single sleeve is used to insulate each pin-socket connection (e.g. the singe sleeve alone is sufficient insulation)). In embodiments, a single sleeve can span each pin-socket connection. In some embodiments, threading each nut to the sleeve can provide compression (e.g. to the pin-socket connection within the sleeve) and/or can provide resistance to loosening (e.g. of the pin-socket connection) (e.g. due to vibration during operation). For example, threading each nut to the corresponding sleeve can mechanically fasten the corresponding pin-socket connection to the pothead (e.g. fix the pin-socket connection within the sleeve).

Typically, the motor has lead-out wires corresponding to the phases of the motor, and the pothead has pins corresponding to the phases of the motor. Accordingly, connections can be made for all pin-socket sets (e.g. for all phases of the motor). In some embodiments, electrically connecting/engaging each socket with the corresponding pin within the corresponding sleeve can form a void space (e.g. between the stop mechanism and the nut and/or between the pin-socket connection and the sleeve), and the method can further comprise filling the void space with oil (e.g. dielectric oil) and/or venting (e.g. substantially all) air from the void space (e.g. with the oil then filling the void space). Some embodiments can further comprise attaching the pothead to the ESP motor (e.g. on-site at the wellsite), and filling the void space with oil may occur after attaching the pothead to the ESP motor. In some embodiments, filling the void space with oil can comprise inputting oil into the ESP motor (e.g. with oil then entering the void space through the venting mechanism(s)). In embodiments, attaching the pothead to the ESP motor can comprise bolting the pothead to a motor head housing (e.g. wherein bolting uses nuts in addition to the insulated nuts configured for threading attachment to the sleeve (e.g. separate bolts and nuts), and wherein the bolts extend through corresponding receiving holes in the body of the pothead (e.g. typically located in an external portion of the pothead body, with the pins disposed between the receiving holes)).

In embodiments, providing a pothead can comprise forming the pothead having a body, the plurality of threaded pins (e.g. extending from the body), and a stop mechanism disposed in the body. In some embodiments, providing a pothead can further comprise disposing a conical section seal within the body of the pothead, wherein the stop mechanism is disposed between the conical section seal and the pins (e.g. the stop mechanism contacts the conical section seal). For example, providing a pothead can comprise providing a pothead as described in FIG. 6. Some embodiments can further comprise removing a shipping cap (e.g. on-site at the wellsite) from the pothead to expose the plurality of pins.

In embodiments, providing an ESP having a motor with a plurality of lead-out wires can comprise pre-assembling each nut and each socket onto the corresponding lead-out wire (e.g. off-site). For example, pre-assembling each nut and each socket onto the corresponding lead-out wire can comprise disposing each nut onto the corresponding lead-out wire, and then attaching (e.g. electrically connecting/coupling, for example by soldering or crimping) each socket to the corresponding lead-out wire. Typically, each nut can be free to rotate and/or slidable on the corresponding lead-out wire. In embodiments, attaching each socket to the corresponding lead-out wire can comprise electrically connecting/coupling each socket to a distal end of the corresponding lead-out wire. In embodiments, disposing each nut onto the corresponding lead-out wire can comprise orienting each nut with threading directed towards the corresponding socket (e.g. towards a distal end of the corresponding led-out wire). Typically, pre-assembling can occur off-site (e.g. away from the well, for example at an assembly facility). In embodiments, providing an insulating sleeve can comprise forming a plurality of sleeves and inspecting and/or testing one or more of the plurality of sleeves (e.g. off-site) (e.g. to ensure that it meets the requirements) (e.g. before pre-assembly). In embodiments, providing an insulating nut can comprise forming a plurality of nuts and inspecting and/or testing one or more of the plurality of nuts (e.g. off-site) (e.g. to ensure that it meets the requirements) (e.g. before pre-assembly). For example, testing can comprise electrically, physically, and/or mechanically testing the sleeve and/or nut. In embodiments, providing an insulating sleeve can comprise forming the sleeve (e.g. off-site, for example by molding).

Method embodiments can further comprise disposing the ESP downhole in a wellbore (e.g. after attaching the pothead to the ESP motor) and operating the ESP to pump fluid to the surface and/or from the well. For example, operating the ESP can comprise providing power to the ESP from the surface through the pothead. Some method embodiments can further comprise removing the ESP from the well (e.g. retrieving the ESP from the well), disconnecting the pothead from the ESP motor, disconnecting the pin-socket connections (e.g. unscrewing the nut from the sleeve, uncoupling the socket from the pin, and unscrewing the sleeve from the pin), and/or re-using the sleeves for another pin-socket connection.

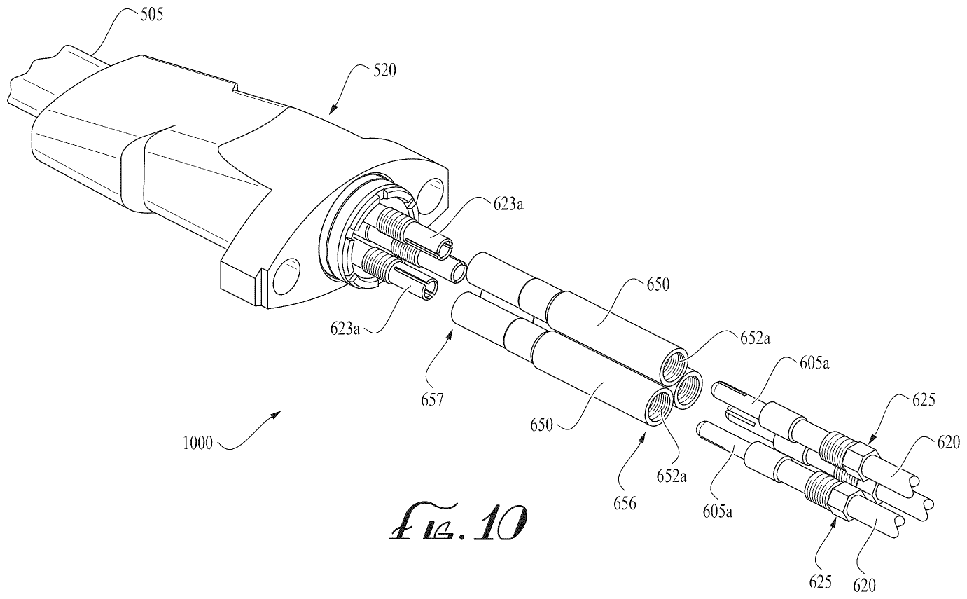

Person of skill will understand that the embodiments of FIGS. 6-9B are merely exemplary, and that similar embodiments (for example in which sockets extend from the pothead and/or pins are coupled to the lead-out wires) are also within the scope of disclosure (e.g. the position of the pins and sockets can be switched). See for example FIGS. 10-12, illustrating a similar method of connection when the pothead has sockets (e.g. with threading) and the lead-out wires have pins (e.g. disposed at their distal end). Additionally, persons of skill will understand that similar embodiments included within the scope of this disclosure can utilize different sorts of electrical connections for the lead-out wires and pothead (e.g. for connection of the motor to the MLE), for example with a similar sleeve providing insulation for the connection and/or a similar installation approach being used (e.g. regardless of the specifics of the electrical connection).

By way of example, FIG. 10 is an exploded isometric view of an alternate exemplary pothead connection system 1000 (e.g. showing the pothead connection prior to assembly on-site at the well), according to an embodiment of the disclosure. The system 1000 of FIG. 10 is similar to those discussed above in many ways (for example, similar in many ways to system 600 of FIG. 6), but the sockets 623a are disposed on (e.g. extend from) the pothead 520 (e.g. electrically coupled to the MLE), while the pins 605a extend from the distal ends of the corresponding lead-out wires 620 (as shown in FIG. 10, for example). The sleeve 650 of FIG. 10 is substantially similar to those discussed above with respect to FIGS. 6-9B. The sockets 623a of FIG. 10 have threading (e.g. in proximity to their base) which is configured for attachment to the pothead-retaining threading 655a of the sleeve 650 (for example when the pothead extension portion of the sleeve 650 is inserted over the socket 623a). The pins 605a of FIG. 10 are configured for insertion into the second end 656 of the corresponding sleeve 650, and the corresponding nut 625 is configured for threading attachment to the distal internal threading 652a on the second end 656 of the sleeve 650. The insulating nut 625 of FIG. 10 is substantially similar to those described with respect to FIGS. 6-9B.

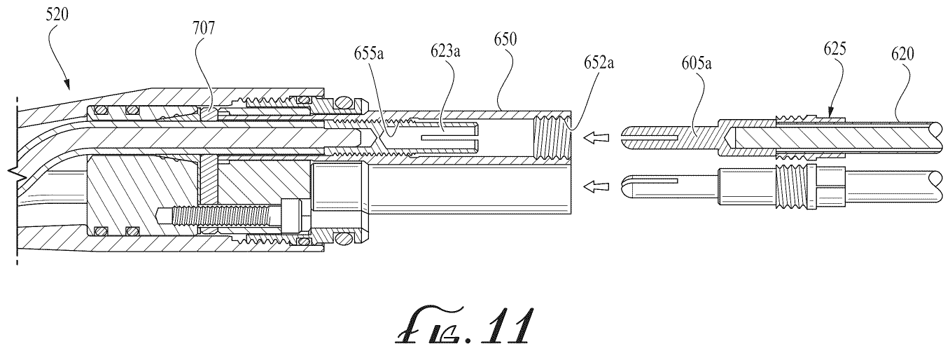

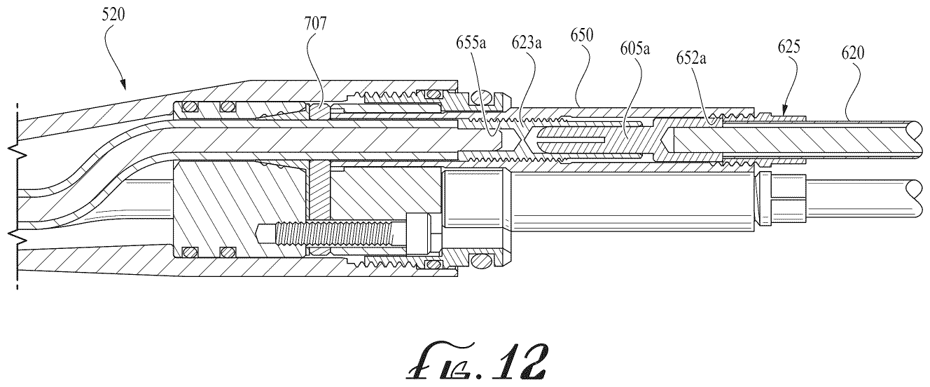

FIG. 11 is a cross-section view of the exemplary pothead connection system of FIG. 10 at a first stage of assembly (e.g. with the insulated sleeves 650 attached to the corresponding sockets 623a of the pothead 520), and FIG. 12 is an isometric view of the pothead connection system of FIG. 10 at a third (e.g. final) stage of assembly (e.g. with assembly complete and/or with the electrical connection fully made-up, for example with the insulated nut 625 coupled to the corresponding sleeve 650). Thus, FIGS. 10-12 taken together can illustrate an exemplary method of electrical connection and/or insulation (e.g. using the system of FIG. 10), which is similar in many ways to that described with respect to FIGS. 6-9B.

For example, in FIG. 11 the sleeve is threaded onto the corresponding socket of the pothead (e.g. with the pothead-retaining threading of the sleeve meshing/mating with the threading of the socket). In embodiments, the sleeve may be screwed on until its first end contacts a stop mechanism disposed within the pothead. Then, as shown in FIG. 12, the pin can be inserted into the corresponding sleeve and electrically coupled to the socket disposed within the sleeve, and the nut can be threaded onto the second end of the sleeve (e.g. with the threading of the nut meshing/mating with the distal internal threading of the second end of the sleeve). In some embodiments, the nut may be tightened until it contacts a shoulder of the pin disposed within the sleeve. Persons of skill will understand such method embodiments based on this disclosure, the related figures, and similar embodiments described herein.

As persons of skill will understand, disclosed pothead embodiments may be derived from and/or use many of the same components from a standard tape-in pothead design, but may instead be configured for use with the discrete insulating sleeve embodiments for improved installation. This may allow some existing component inventory to be utilized with minimum geometrical changes, for example to the motor head and/or pothead (e.g., pothead pins may be upgraded to threaded pins, lead-out wire sockets may be updated to include insulated nuts, and/or discrete sleeves may be provided for on-site installation of insulation, with the option of upgrading existing components). Motors with a modified electrical connection/insulation system may be used with either the insulating sleeve or tape-in approach. This may provide the option to revert to a standard tape-in pothead in instances by simply removing the insulating sleeve components, even at the well site. Accordingly, several internal components of the disclosed embodiments may be interchangeable with and/or similar to a comparable tape-in pothead system.

Disclosed embodiments may provide one or more of the following benefits, for example including: Improved consistency of insulation of the pin-socket connection (e.g. insulation rating can be determined by designed geometry (e.g. thicknesses, gaps, tracking lengths, etc.) rather than by approximation of manual assembly, for example by tape-in); more secure electrical connections (e.g. pin-socket electrical connections can be physically restrained by engineered means rather than merely held by friction within the connector); improved assembly consistency (e.g. repeatable positioning, for example due to designed components and hard stops); improved inspection and/or testing (for example due to use of engineered parts rather than on-site make-up of insulation, which may lead to less waste and/or less need to redo insulation) (e.g. component parts can be inspected and tested before use); improved traceability (e.g. for better detection of issues and ability to address issues, for example in future designs); reduced probability of electrical failure from inconsistent positioning of insulation; reduced need for skilled labor (e.g. less training may be required for effective insulation during installation at wellsite, for example due to engineered components eliminating need for tape-in skill set); reduced time taken to make up the electrical connection at the well site; reduced human error and/or variability in assembly, and reduced probability of overheating due to entrapped air around the connector (e.g. better distribution of oil around connection). Disclosed embodiments may include pothead connection systems and methods which may minimize such risks.

### ADDITIONAL DISCLOSURE

The following are non-limiting, specific embodiments in accordance with the present disclosure:

In a first embodiment, an electrical connection system (e.g. for an ESP configured for downhole use in a well) can comprise: a pothead; one or more (e.g. typically a plurality of) motor lead-out wires (e.g. stator leads) coupled to and/or in electrical communication with (e.g. a motor of) the ESP (e.g. the stator of the ESP); and an insulating sleeve corresponding to (but discrete from) each lead-out wire and/or pothead connection (e.g. pin or socket); wherein: each lead-out wire is electrically coupled to (e.g. soldered and/or crimped to) one of a pin or a connecting socket (e.g. with the socket corresponding to and/or configured to electrically engage with the pin); the pothead comprises one or more corresponding other of the pin or the socket, wherein each corresponding pin-socket set is configured for electrical connection/coupling when engaged (e.g. wherein each pin is configured for electrical connection to the corresponding socket (e.g. by plug-in engagement, for example with the pin being received within the socket)); each pin or socket of the pothead comprises threading (e.g. located externally on its base); for each lead-out wire, a nut is disposed on the corresponding lead-out wire, wherein the nut comprises threading (e.g. with the nut oriented with the threading towards the corresponding pin or socket coupled to the lead-out wire, for example facing a distal end of the corresponding lead-out wire); each insulating sleeve comprises a first end configured for engagement with (e.g. configured to receive) one of the pin or the socket of the pothead, and a second end (e.g. opposite the first end) configured for engagement with (e.g. configured to receive) the corresponding other of the pin or the socket (e.g. of the corresponding lead-out line); the second end of each insulating sleeve comprises distal internal threading corresponding to the threading of the corresponding nut (e.g. the distal internal threading is disposed in proximity to the second end) (e.g. the second end is configured to mesh via screwing for engagement with the threading of the corresponding nut, for example to mechanically retain the corresponding pin-socket connection within the sleeve); and the sleeve further comprises internal pothead-retaining threading corresponding to the threading of the pin or socket of the pothead (e.g. configured for meshing attachment via screwing for engagement of the sleeve with the threading of the corresponding pin or socket of the pothead, for example to mechanically retain the sleeve onto the corresponding pin or socket of the pothead).

A second embodiment can include the system of the first embodiment, wherein the internal pothead-retaining threading is spaced from both the first end and the second end (e.g. disposed between the first and second ends).

A third embodiment can include the system of the first or second embodiment, wherein there is only a single sleeve per pin-socket connection.

A fourth embodiment can include the system of any one of the first to third embodiments, wherein each nut is insulating (e.g. the nut comprises an insulating nut).

A fifth embodiment can include the system of any one of the first to fourth embodiments, wherein the sleeve is configured to span and to effectively insulate the corresponding pin-socket connection (e.g. engagement of the pin and corresponding socket) (e.g. no additional insulation is needed).

A sixth embodiment can include the system of any one of the first to fifth embodiments, wherein a pothead extension portion of the sleeve extends axially away from proximity to the internal pothead-retaining threading to the first end (e.g. with the internal pothead-retaining threading disposed on the sleeve's interior surface away from proximity with the first or second end and/or on the sleeve's interior surface in proximity to the transition between the wire connection portion and the pothead extension portion) (e.g. wherein the internal pothead-retaining threading is disposed on the interior surface of the pothead extension portion of the sleeve, for example located away from the first end and/or located in proximity to the junction of the pothead extension portion and the wire connection portion).

A seventh embodiment can include the system of any one of the first to sixth embodiments, wherein a wire connection portion of the sleeve extends axially from proximity to the internal pothead-retaining threading to the second end (e.g. with the distal internal threading that corresponds to the threading of the corresponding nut).

An eighth embodiment can include the system of any one of the sixth to seventh embodiments, wherein the pothead extension portion is configured to extend into a body of the pothead, beyond the base of the corresponding pin or socket of the pothead, and/or to contact a stop mechanism (e.g. when threadingly coupled to the corresponding pin or socket of the pothead).

A ninth embodiment can include the system of any one of the sixth to eighth embodiments, wherein the pothead extension portion has a smaller inner diameter than the wire connection portion (e.g. the first end of the sleeve has a smaller diameter than the second end of the sleeve).

A tenth embodiment can include the system of any one of the seventh to ninth embodiments, wherein the wire connection portion has an axial length at least as great (e.g. typically greater, for example by approximately the amount of threading) as the corresponding pin or socket of the corresponding lead-out wire (e.g. received therein).

An eleventh embodiment can include the system of any one of the first to tenth embodiments, wherein the sleeve effectively insulates the pin-socket connection without the need for any insulating taping (e.g. the sleeve alone is sufficient for effective insulation, and there is no taping of each pin-socket connection or of a plurality of connections together).

A twelfth embodiment can include the system of any one of the first to eleventh embodiments, wherein the distal internal threading does not sealingly mesh with the threading of the corresponding nut.

A thirteenth embodiment can include the system of any one of the first to twelfth embodiments, wherein engagement of the pin and the corresponding socket (e.g. electrical coupling of the lead-out wire and the pothead) occurs within the sleeve (e.g. formation of the pin-socket connection occurs within the sleeve).

A fourteenth embodiment can include the system of any one of the first to thirteenth embodiments, wherein the pothead further comprises a stop mechanism (e.g. an internal disc, which can be oriented perpendicular to the longitudinal axis of the pothead and/or the pins or sockets of the pothead) configured for contact with the first end of the sleeve and/or configured to locate the first end of the sleeve axially within the body of the pothead (e.g. by contact, for example as the sleeve is threaded onto the corresponding pin or sleeve of the pothead).

A fifteenth embodiment can include the system of the fourteenth embodiment, wherein the first end of the sleeve is configured to contact the stop mechanism when threadingly engaged to the corresponding pin or socket of the pothead (e.g. with the stop mechanism, positively locating the sleeve axially within the body of the pothead when the internal pothead-retaining threads mesh with the threading of the corresponding pin or socket of the pothead).

A sixteenth embodiment can include the system of any one of the first to fifteenth embodiments, wherein a void is formed (e.g. radially) between the pin-socket connection and the corresponding sleeve (e.g. with the sleeve encompassing the pin-socket connection and/or with the pin-socket connection disposed entirely within the corresponding sleeve), wherein the void is configured to vent between the corresponding nut and the corresponding lead-out wire and/or between/through the threading connection of the nut to the second end of the sleeve (e.g. to the distal internal threading).

A seventeenth embodiment can include the system of the sixteenth embodiment, wherein the void extends axially between the stop mechanism and the nut.

An eighteenth embodiment can include the system of any one of the first to seventeenth embodiments, wherein the threading connection of the nut to the second end of the sleeve is not sealed (e.g. not a sealed connection) and/or wherein the nut is not sealingly coupled to and/or located on the corresponding lead-out wire (e.g. providing venting therethrough).

A nineteenth embodiment can include the system of any one of the sixteenth to eighteenth embodiments, wherein oil (e.g. dielectric oil) fills the void and/or wherein there is no air trapped in the void (e.g. when the pothead is coupled/secured to the motor and/or when the motor is in use).

In a twentieth embodiment, an electrical connection system (e.g. for an ESP configured for downhole use in a well) can comprise: a pothead; one or more (e.g. typically a plurality of) lead-out wires (e.g. stator leads) coupled to and/or in electrical communication with (e.g. a motor of) the ESP (e.g. the stator of the ESP); and an insulating sleeve corresponding to (but discrete from) each lead-out wire; wherein: each lead-out wire is coupled (e.g. soldered and/or crimped) to a connecting socket; the pothead comprises a pin corresponding to each socket or lead-out wire, wherein each corresponding pin-socket set is configured for electrical connection/coupling when engaged (e.g. wherein each pin is configured for electrical connection to the corresponding socket (e.g. by plug-in engagement, with the pin received within the socket)); each pin comprises threading (located externally on its base); (e.g. for each socket or lead-out wire) an insulating nut is disposed on the corresponding lead-out wire, wherein the nut comprises threading (e.g. with the nut oriented with the threading towards the socket); each insulating sleeve comprises a first end configured for engagement with (e.g. configured to receive) the corresponding pin, and a second end configured for engagement with (e.g. configured to receive) the corresponding socket; the second end of each insulating sleeve comprises distal internal threading corresponding to the threading of the corresponding nut (e.g. configured to mesh/mate via screwing for engagement with the threading of the corresponding nut, for example to mechanically retain the corresponding socket within the sleeve); and the sleeve further comprises internal pothead-retaining threading corresponding to the threading of the corresponding pin (e.g. configured for meshing attachment via screwing for engagement with the threading of the corresponding pin, for example to mechanically retain the sleeve onto the pin and/or pothead), wherein the internal pothead-retaining threading is spaced from both the first end and the second end.

A twenty-first embodiment can include the system of the twentieth embodiment, wherein there is only a single sleeve per pin-socket connection and/or wherein the sleeve is configured to span and to effectively insulate the corresponding pin-socket connection (e.g. engagement of the pin and corresponding socket).

A twenty-second embodiment can include the system of any one of the twentieth to twenty-first embodiments, wherein the internal pothead-retaining threading is disposed between the first and second ends, with a pothead extension portion of the sleeve extending axially away from proximity to the internal pothead-retaining threading to the first end (e.g. with the internal pothead-retaining threading disposed on its interior surface and located away from the first end).

A twenty-third embodiment can include the system of the twenty-second embodiment, wherein the pothead extension portion is configured to extend into a body of the pothead, beyond the base of the corresponding pin, and to contact a stop mechanism (e.g. when threadingly coupled to the corresponding pin).

A twenty-fourth embodiment can include the system of any one of the twenty-second to twenty-third embodiments, wherein a wire connection portion of the sleeve extends axially from proximity to the internal pothead-retaining threading to the second end (e.g. with the distal internal threading disposed on its interior surface in proximity to the second end) (e.g. with the wire connection portion extending axially away from the pothead extension portion to the second end) (e.g. wherein the wire connection portion and the pothead extension portion are axially aligned, for example both extending axially along the longitudinal axis of the sleeve, with the wire connection portion extending from its junction with the pothead extension portion (e.g. its interior end) to the second end, and with the pothead extension portion extending from its junction with the wire connection portion (e. g its interior end) to the first end).

A twenty-fifth embodiment can include the system of the twenty-fourth embodiment, wherein the pothead extension portion has a smaller inner diameter than the wire connection portion (e.g. the first end of the sleeve has a smaller diameter than the second end of the sleeve).

A twenty-sixth embodiment can include the system of any one of the twenty-fourth to twenty-fifth embodiments, wherein the wire connection portion has an axial length at least as great (e.g. typically greater, for example by the amount of threading) as the corresponding socket (e.g. received therein).

A twenty-seventh embodiment can include the system of any one of the twentieth to twenty-sixth embodiments, wherein the sleeve effectively insulates the corresponding pin-socket connection without the need for any insulating tape (e.g. the sleeve alone is sufficient for effective insulation, and there is no taping of each pin-socket connection or of a plurality of connections together).

A twenty-eighth embodiment can include the system of any one of the twentieth to twenty-seventh embodiments, wherein the distal internal threading does not sealingly mesh with the threading of the corresponding nut.

A twenty-ninth embodiment can include the system of any one of the twentieth to twenty-eighth embodiments, wherein engagement of the pin and the corresponding socket occurs within the sleeve.

A thirtieth embodiment can include the system of any one of the twentieth to twenty-ninth embodiments, wherein the nut is configured to secure the corresponding socket within the corresponding sleeve, when threadingly engaged/secured with the second end of the corresponding sleeve.

A thirty-first embodiment can include the system of any one of the twentieth to thirtieth embodiments, wherein the nut is configured to abut the corresponding socket (e.g. a shoulder of the socket), when threadingly engaged with the second end of the corresponding sleeve (e.g. with the socket disposed within the corresponding sleeve) and/or to provide compression and/or to resist loosening (e.g. due to vibration) (e.g. of the pin-socket connection).

A thirty-second embodiment can include the system of any one of the twentieth to thirty-first embodiments, wherein each insulating nut is free to rotate about and/or is slidable on the corresponding lead-out wire.

A thirty-third embodiment can include the system of any one of the twentieth to thirty-second embodiments, wherein the insulating sleeve is coupled (e.g. by meshing thread attachment) to the corresponding pin at the first end and is coupled (e.g. by meshing thread attachment) to the corresponding insulating nut at the second end.

A thirty-fourth embodiment can include the system of any one of the twentieth to thirty-third embodiments, wherein the pothead further comprises a stop mechanism (e.g. an internal disc) configured for contact with the first end of the sleeve and/or configured to locate the first end of the sleeve axially within the body of the pothead (e.g. by contact).

A thirty-fifth embodiment can include the system of the thirty-fourth embodiment, wherein the first end of the sleeve is configured to contact the stop mechanism when threadingly engaged to the corresponding pin (e.g. with the stop mechanism, positively locating the sleeve axially within the body of the pothead).

A thirty-sixth embodiment can include the system of any one of the twentieth to thirty-fifth embodiments, wherein a void is formed (e.g. radially) between the pin-socket connection and the corresponding sleeve (e.g. with the sleeve encompassing the pin-socket connection and/or with the pin-socket connection disposed entirely within the corresponding sleeve), wherein the void is configured to vent between the corresponding nut and the corresponding lead-out wire and/or between/through the threading connection of the nut to the second end of the sleeve.

A thirty-seventh embodiment can include the system of the thirty-sixth embodiment, wherein the void extends axially between the stop mechanism and the insulating nut.

A thirty-eighth embodiment can include the system of any one of the thirty-fourth to thirty-seventh embodiments, wherein the stop mechanism contacts a conical section seal of the pothead opposite the sleeve.

A thirty-ninth embodiment can include the system of any one of the twentieth to thirty-eighth embodiments, wherein the threading connection of the nut to the second end of the sleeve is not sealed (e.g. not a sealed connection) and/or wherein the nut is not sealingly coupled to and/or located on the corresponding lead-out wire (e.g. providing venting therethrough).

A fortieth embodiment can include the system of any one of the thirty-sixth to thirty-ninth embodiments, wherein oil (e.g. dielectric oil) fills the void and/or wherein there is no air trapped in the void.

A forty-first embodiment can include the system of any one of the twentieth to fortieth embodiments, wherein the socket (and nut) is pre-attached to the corresponding lead-out wire (e.g. not attached on site, but pre-assembled).

A forty-second embodiment can include the system of any one of the twentieth to forty-first embodiments, wherein the one or more lead-out wires comprises a plurality of lead-out wires which corresponds in number to the phases of the ESP motor (e.g. stator) (and the number of pins corresponds to the number of lead-out wires, the number of sockets corresponds to the number of lead-out wires, and the number of nuts corresponds to the number of lead-out wire).

A forty-third embodiment can include the system of the forty-second embodiment, wherein the plurality of lead-out wires (and corresponding pins, sockets, and nuts) comprises three (3) lead-out wires (and corresponding pins, sockets, and nuts).

A forty-fourth embodiment can include the system of any one of the twentieth to forty-third embodiments, wherein the pothead (e.g. its body) further comprises an affixing mechanism (e.g. corresponding bolts and holes in the body of the pothead) configured to secure the pothead to the motor of the ESP.

In a forty-fifth embodiment, an insulating sleeve for a pin-socket connection of a pothead to a lead-out wire of an ESP can comprise: a hollow elongate body having a first end configured for engagement with (e.g. configured to receive) one of the pin or socket of the pothead, and a second end configured for engagement with (e.g. configured to receive) the other of the pin or socket of the corresponding motor lead-out wire; wherein: the second end of the hollow elongate body comprises distal internal threading (e.g. threading disposed on its internal surface and located in proximity to the second end of the hollow elongate body) (e.g. corresponding to threading of a nut of the corresponding lead-out wire, e.g. configured to mesh via screwing for engagement with the threading of the corresponding nut, for example to mechanically retain the corresponding socket within the sleeve); and the hollow elongate body further comprises internal pothead-retaining threading (e.g. threading disposed on its internal surface corresponding to the threading of the corresponding pin or socket of the pothead, e.g. configured for meshing attachment via screwing for engagement with the threading of the corresponding pin or socket of the pothead, for example to mechanically retain the sleeve to pothead), wherein the internal pothead-retaining threading is spaced from both the first end and the second end (e.g. disposed between the first and second end of the sleeve).

A forty-sixth embodiment can include the sleeve of the forty-fifth embodiment, wherein the hollow elongate body comprises a bore therethrough, extending axially from the first end to the second end.

A forty-seventh embodiment can include the sleeve of the forty-sixth embodiment, wherein the first end of the bore is configured to receive the corresponding pin or socket of the pothead and the second end of the bore is configured to receive the corresponding pin or socket of the ESP motor lead-out wire (e.g. wherein the diameter of the bore at the first end is less than the diameter of the bore at the second end or vice versa).

A forty-eighth embodiment can include the sleeve of any one of the forty-fifth to forty-seventh embodiments, wherein the hollow elongate body is configured to span and to effectively insulate the corresponding pin-socket connection (e.g. engagement of the pin and corresponding socket).

A forty-ninth embodiment can include the sleeve of any one of the forty-fifth to forty-eighth embodiments, wherein the internal pothead-retaining threading is disposed between the first and second ends of the hollow elongate body, with a pothead extension portion of the sleeve extending axially away from proximity to the internal pothead-retaining threading to the first end (e.g. the internal pothead-retaining threading is disposed on the interior surface of the pothead extension portion away from the first end (e.g. in proximity to the pothead extension portion's interior end)).

A fiftieth embodiment can include the sleeve of any one of the forty-fifth to forty-ninth embodiments, wherein a wire connection portion of the sleeve extends axially from proximity to the internal pothead-retaining threading to the second end (e.g. the end with the distal internal threading disposed on its interior surface) (e.g. the distal internal threading is disposed on the interior surface of the wire connection portion in proximity to the second end) (e.g. the wire connection portion and the pothead extension portion both extend axially along the longitudinal centerline axis of the sleeve, with the pothead extension portion extending from the junction with the wire connection portion (e.g. its internal end) to the first end, and with the wire connection portion extending from the junction with the pothead extension portion (e.g. its internal end) to the second end) (e.g. with the internal pothead-retaining threading disposed in proximity to the transition/junction between the pothead extension portion and the wire connection portion).

A fifty-first embodiment can include the sleeve of the fiftieth embodiment, wherein the wire connection portion has a substantially constant bore diameter (e.g. along its axial length), the pothead extension portion has a substantially constant bore diameter (e.g. along its axial length), and the bore diameter of the pothead extension portion differs from the bore diameter of the wire connection portion.

A fifty-second embodiment can include the sleeve of any one of the fiftieth to fifty-first embodiments, wherein the bore diameter of the pothead extension portion is less than the bore diameter of the wire connection portion (e.g. the pothead extension portion has a smaller inner diameter than the wire connection portion and/or the first end of the sleeve has a smaller diameter than the second end of the sleeve) (although in other embodiments, the wire connection portion bore may be smaller).

A fifty-third embodiment can include the sleeve of any one of the forty-ninth to fifty-second embodiments, wherein the pothead extension portion is configured to extend into a body of the pothead, beyond a base of the corresponding pin or socket (of the pothead), and to contact a stop mechanism (e.g. when threadingly coupled to the corresponding pin or socket).

A fifty-fourth embodiment can include the sleeve of any one of the fiftieth to fifty-third embodiments, wherein the wire connection portion has an axial length at least as great (e.g. typically greater, for example by the amount of threading) as the corresponding socket or pin (e.g. of the lead-out wire and/or as received therein).

A fifty-fifth embodiment can include the sleeve of any one of the forty-fifth to fifty-fourth embodiments, wherein the sleeve is configured to effectively insulate the pin-socket connection without the need for any insulating tape (e.g. the sleeve alone is sufficient for effective insulation, and there is no taping of each pin-socket connection or of a plurality of connections together).

A fifty-sixth embodiment can include the sleeve of any one of the forty-fifth to fifty-fifth embodiments, wherein the distal internal threading (e.g. at the second end) does not sealingly mesh with the threading of the corresponding nut.

A fifty-seventh embodiment can include the sleeve of any one of the forty-fifth to fifty-sixth embodiments, wherein the insulating sleeve is configured to be coupled (e.g. by meshing thread attachment) to the corresponding pin or socket of the pothead at the first end, and is configured to be coupled (e.g. by meshing thread attachment) to the corresponding insulating nut of the lead-out wire at the second end.

A fifty-eighth embodiment can include the sleeve of any one of the forty-fifth to fifty-seventh embodiments, wherein the first end of the sleeve is configured to contact a stop mechanism of the pothead (e.g. in order to locate the first end of the sleeve axially within the body of the pothead) (e.g. when the sleeve is threadingly engaged to the corresponding pin or socket of the pothead).

A fifty-ninth embodiment can include the sleeve of any one of the forty-fifth to fifty-eighth embodiments, wherein the hollow elongate body is configured so that a void is formed (e.g. radially) between the pin-socket connection (received therein) and the corresponding sleeve (e.g. with the hollow elongate body encompassing the pin-socket connection and/or with the pin-socket connection disposed entirely within the corresponding hollow elongate body).

A sixtieth embodiment can include the sleeve of the fifty-ninth embodiment, wherein the void is configured to extend axially between the stop mechanism and the insulating nut.

A sixty-first embodiment can include the sleeve of any one of the forty-fifth to sixtieth embodiments, wherein the body of the sleeve comprises a single (e.g. unitary) substantially cylindrical element (e.g. substantially symmetrical about its longitudinal centerline axis) (e.g. in some embodiments, the hollow elongate body, while substantially cylindrical, may have a different outer diameter for the wire connection portion and the pothead extension portion and/or may have a different inner/bore diameter for the wire connection portion and the pothead extension portion).

A sixty-second embodiment can include the sleeve of any one of the forty-fifth to sixty-first embodiments, wherein the sleeve is a unitary element (e.g. a single solid element and/or integrally formed).

A sixty-third embodiment can include the sleeve of any one of the forty-fifth to sixty-second embodiments, wherein the sleeve is pre-formed (e.g. molded) off-site.

In a sixty-fourth embodiment, a method of installing an ESP at a well can comprise: providing (e.g. on-site at the wellsite) a pothead having a plurality of pins or sockets, each with threading (e.g. disposed at its base); providing (e.g. on-site at the wellsite) the ESP having a motor with a plurality of lead-out wires (e.g. corresponding to the phases of the motor), each having a socket or pin (e.g. electrically coupled to its distal end, and configured to mate with the corresponding pin or socket of the pothead) and a corresponding insulating nut (e.g. disposed on the lead-out wire), wherein the plurality of lead-out wires is equal in number to the plurality of pins or sockets of the pothead; providing (e.g. on-site at the wellsite) a plurality of insulating sleeves (e.g. equal in number to the lead-out wires); threading (e.g. on-site at the wellsite) each insulating sleeve (e.g. its first end) onto the corresponding pin or socket of the pothead; inserting (e.g. on-site at the wellsite) each socket or pin of the corresponding lead-out wire into the corresponding sleeve (e.g. at its second end); electrically connecting/engaging/coupling (e.g. on-site at the wellsite) the pins or sockets of the pothead with the corresponding socket or pin of the lead-out wire (e.g. by pushing the socket onto the pin or the pin into the socket, for example within the sleeve), wherein a corresponding pin-socket connection is disposed within the corresponding sleeve; and threading (e.g. on-site at the wellsite) each nut to the corresponding sleeve (e.g. to retain the pin-socket connection within the sleeve).

A sixty-fifth embodiment can include the method of the sixty-fourth embodiment, wherein threading each insulating sleeve onto the corresponding pin or socket of the pothead, inserting each socket or pin of the lead-out wire into the corresponding sleeve, electrically connecting each socket with the corresponding pin, and threading each nut to the sleeve all occur on-site (e.g. at the wellsite).

A sixty-sixth embodiment can include the method of any one of the sixth-fourth to sixty-fifth embodiments, wherein each sleeve is initially (e.g. when provided on-site) separate and distinct from the corresponding pothead and/or the corresponding lead-out wire (e.g. the sleeve is not integral and/or integrated, but is its own distinct and separate element).

A sixty-seventh embodiment can include the method of any one of the sixth-fourth to sixty-sixth embodiments, wherein threading each insulating sleeve onto the corresponding pin or socket of the pothead occurs before electrically connecting/engaging the pins or sockets of the pothead with the corresponding socket or pin of the lead-out wire and/or before threading each nut to the sleeve (although in other embodiments, the nut could be threaded to the sleeve before the sleeve is threaded to the corresponding pin and/or electrically connecting/engaging each socket with the corresponding pin could occur before threading the sleeve onto the corresponding pin or socket).

A sixty-eighth embodiment can include the method of any one of the sixth-fourth to sixty-seventh embodiments, wherein each sleeve comprises threading configured for meshing attachment to the threading of the corresponding pin or socket of the pothead (e.g. internal pothead-retaining threading), and wherein each sleeve comprises threading configured for meshing attachment to the threading of the corresponding nut of the lead-out wire (e.g. distal internal threading).

A sixty-ninth embodiment can include the method of the sixty-eighth embodiment, wherein the threading configured for meshing attachment to the threading of the corresponding nut of the lead-out wire (e.g. distal internal threading) is disposed at an end (e.g. the second end) of the sleeve (e.g. on its internal surface), and wherein the threading configured for meshing attachment to the threading of the corresponding pin or socket of the pothead (e.g. internal pothead-retaining threading) is disposed between ends of the sleeve (e.g. away from both the first and second ends of the sleeve).

A seventieth embodiment can include the method of any one of the sixth-eighth to sixty-ninth embodiments, wherein a wire connection portion of the sleeve extends axially from the threading configured for meshing attachment to the corresponding pin or socket of the pothead (e.g. internal pothead-retaining threading) toward the end of the sleeve (e.g. the second end) with the threading configured for meshing attachment to the corresponding nut of the lead-out wire (e.g. distal internal threading), and wherein a pothead extension portion of the sleeve extends axially away from the threading configured for meshing attachment to the corresponding pin or socket of the pothead (e.g. internal pothead-retaining threading) toward an opposite end of the sleeve (e.g. the first end, opposite the end of the sleeve having the threading configured for meshing attachment to the corresponding nut of the lead-out wire).

A seventy-first embodiment can include the method of the seventieth embodiment, wherein the pothead extension portion is configured to extend into a body of the pothead, beyond a base of the corresponding pin or socket of the pothead, and to contact a stop mechanism (e.g. when threadingly coupled to the corresponding pin or socket of the pothead).

A seventy-second embodiment can include the method of any one of the sixth-fourth to seventy-first embodiments, wherein threading each insulating sleeve onto the corresponding pin or socket of the pothead comprises disposing the pothead extension portion of the sleeve within a body of the pothead, wherein the pothead extension portion extends axially into the body of the pothead beyond the pin or socket (e.g. further internal to the pothead, beyond the base of the pin or socket).

A seventy-third embodiment can include the method of any one of the sixth-fourth to seventy-second embodiments, wherein inserting each socket or pin of the lead-out wire into the corresponding sleeve comprises inserting each socket or pin of the lead-out wire into the wire connection portion of the sleeve (e.g. via the second end of the sleeve).

A seventy-fourth embodiment can include the method of any one of the sixth-fourth to seventy-third embodiments, wherein threading the sleeve onto the pin or socket of the pothead, inserting the socket or pin of the lead-out wire into the sleeve, electrically connecting the socket with the pin, and threading the nut of the lead-out wire to the sleeve occur at the wellsite (e.g. in the field and/or in proximity to the well).

A seventy-fifth embodiment can include the method of any one of the sixth-fourth to seventy-fourth embodiments, wherein electrically connecting each socket or pin of the lead-out wire with the corresponding pin or socket of the pothead occurs within the corresponding sleeve (e.g. engagement occurs within the corresponding sleeve).

A seventy-sixth embodiment can include the method of any one of the sixth-fourth to seventy-fifth embodiments, further comprising removing a shipping cap (e.g. on-site at the wellsite) from the pothead to expose the plurality of pins or sockets (e.g. wherein providing the pothead comprises removing a shipping cap from the pothead to expose the plurality of pins of sockets).

A seventy-seventh embodiment can include the method of any one of the sixth-fourth to seventy-sixth embodiments, wherein threading each insulating sleeve onto the corresponding pin or socket of the pothead comprises threading the sleeve until the sleeve contacts a stop mechanism (e.g. internal disc) within a body of the pothead (e.g. configured to provide a hard stop for assembly of the sleeve onto the pothead) (for example, inserting the sleeve onto the corresponding pin or socket of the pothead and screwing the sleeve onto the pin or socket of the pothead, typically until contact with the stop mechanism).

A seventy-eighth embodiment can include the method of the seventy-seventh embodiments, wherein threading the sleeve until the sleeve contacts a stop mechanism comprises inserting the pothead extension portion of the sleeve (e.g. the first end) into the body of the pothead until it contacts the stop mechanism.

A seventy-ninth embodiment can include the method of any one of the sixth-fourth to seventy-eighth embodiments, further comprising positively locating each sleeve within the pothead (e.g. by contacting the stop mechanism).

An eightieth embodiment can include the method of any one of the sixth-fourth to seventy-ninth embodiments, wherein threading each nut of the lead-out line to the sleeve comprises threading the nut until it abuts the socket or pin of the lead-out line disposed in the sleeve (e.g. abuts a shoulder of the socket or pin).

An eighty-first embodiment can include the method of any one of the sixth-fourth to eightieth embodiments, wherein electrically connecting/engaging each socket or pin of the lead-out line with the corresponding pin or socket of the pothead within the corresponding sleeve further comprises insulating the pin-socket connection (e.g. with the sleeve).

An eighty-second embodiment can include the method of the eighty-first embodiment, wherein insulating the pin-socket connection occurs without any taping (e.g. no use of insulating tape) (e.g. no insulated taping of the pin-socket connection on site).

An eighty-third embodiment can include the method of any one of the eighty-first to eighty-second embodiments, wherein insulating the pin-socket connection uses only the corresponding sleeve for insulation (and wherein only a single insulated sleeve is used to insulate each pin-socket connection (e.g. the singe sleeve alone is sufficient insulation)).

An eighty-fourth embodiment can include the method of any one of the sixth-fourth to eighty-third embodiments, wherein a single sleeve spans each pin-socket connection and/or extends into the pothead into contact with the stop mechanism.

An eighty-fifth embodiment can include the method of any one of the sixth-fourth to eighty-fourth embodiments, wherein the motor has lead-out wires correspond to the phases of the motor, wherein the pothead has pins or sockets corresponding to the phases of the motor, and wherein connections are made for all pin-socket sets (e.g. for all phases of the motor).

An eighty-sixth embodiment can include the method of any one of the sixth-fourth to eighty-fifth embodiments, wherein electrically connecting/engaging each socket or pin of the lead-out wires with the corresponding pin or socket of the pothead within the corresponding sleeve comprises forming a void space (e.g. between the stop mechanism and the nut and/or between the pin-socket connection and the sleeve).

An eighty-seventh embodiment can include the method of the eighty-sixth embodiment, further comprising filling the void space with oil (e.g. dielectric oil) and/or venting (e.g. substantially all) air from the void space (e.g. with the oil then filling the void space and/or displacing the air).

An eighty-eighth embodiment can include the method of any one of the sixth-fourth to eighty-seventh embodiments, further comprising attaching the pothead to the ESP motor (e.g. on-site at the wellsite).

An eighty-ninth embodiment can include the method of any one of the eighty-seventh to eighty-eighth embodiments, wherein filling the void space with oil occurs after attaching the pothead to the ESP motor.

A ninetieth embodiment can include the method of any one of the eighty-seventh to eighty-ninth embodiments, wherein filling the void space with oil comprises inputting oil into the ESP motor (e.g. with oil from the motor then flowing into the void space, for example between the threading of the nut to the second end of the sleeve and/or between the nut and the lead-out wire).

A ninety-first embodiment can include the method of any one of the eighty-eighth to ninetieth embodiments, wherein attaching the pothead to the ESP motor comprises bolting the pothead to a motor head housing (e.g. wherein bolting can use nuts in addition to/other than the insulated nuts configured for threading attachment to the sleeve).

A ninety-second embodiment can include the method of any one of the sixth-fourth to ninety-first embodiments, wherein providing a pothead comprises forming (e.g. pre-assembling) the pothead having a body, the plurality of threaded pins or sockets (e.g. extending from the body), and a stop mechanism disposed in the body (e.g. off-site).

A ninety-third embodiment can include the method of the ninety-second embodiment, wherein providing a pothead further comprises disposing a conical section seal within the body of the pothead, wherein the stop mechanism is disposed between the conical section seal and the pins or sockets of the pothead (e.g. the stop mechanism contacts the conical section seal).

A ninety-fourth embodiment can include the method of any one of the sixth-fourth to ninety-third embodiments, wherein providing a pothead comprises providing a pothead as described in any one of the first to forty-fourth embodiments and/or wherein the system used for the method comprises any one of the first to forty-fourth embodiments.

A ninety-fifth embodiment can include the method of any one of the sixth-fourth to ninety-fourth embodiments, wherein providing an ESP having a motor with a plurality of lead-out wires comprises pre-assembling each nut and each socket or pin onto the corresponding lead-out wire (e.g. off-site).

A ninety-sixth embodiment can include the method of the ninety-fifth embodiment, wherein pre-assembling each nut and each socket or pin onto the corresponding lead-out wire comprises disposing each nut onto the corresponding lead-out wire, and then attaching (e.g. electrically connecting/coupling, for example by soldering or crimping) each socket or pin to the corresponding lead-out wire (e.g. electrically connecting/coupling each socket or pin to a distal end of the corresponding lead-out wire).

A ninety-seventh embodiment can include the method of any one of the sixth-fourth to ninety-sixth embodiments, wherein each nut is free to rotate about and/or is slidable on the corresponding lead-out wire.

A ninety-eighth embodiment can include the method of any one of the ninety-sixth to ninety-seventh embodiments, wherein disposing each nut onto the corresponding lead-out wire comprise orienting each nut with threads directed towards the corresponding socket or pin of the lead-out wire (e.g. towards a distal end of the corresponding lead-out wire).

A ninety-ninth embodiment can include the method of any one of the sixth-fourth to ninety-eighth embodiments, wherein pre-assembling occurs off-site (e.g. away from the well, for example at an assembly facility).

A one hundredth embodiment can include the method of any one of the sixth-fourth to ninety-ninth embodiments, wherein providing an insulating sleeve comprises forming a plurality of sleeves and inspecting and/or testing one or more of the plurality of sleeves (e.g. off-site) (e.g. to ensure that it meets the requirements); and/or wherein providing an insulating nut comprises forming a plurality of nuts and inspecting and/or testing one or more of the plurality of nuts (e.g. off-site) (e.g. to ensure that it meets the requirements) (e.g. before pre-assembly) (for example, with testing comprising electrically, physically, and/or mechanically testing the sleeve and/or nut).

A one hundred first embodiment can include the method of any one of the sixth-fourth to one hundredth embodiments, wherein providing an insulating sleeve comprises providing any one of the forty-fifth to sixty-third sleeve embodiments.

A one hundred second embodiment can include the method of any one of the sixth-fourth to one hundred first embodiments, wherein providing an insulating sleeve comprises forming the sleeve (e.g. off-site).

A one hundred third embodiment can include the method of any one of the sixth-fourth to one hundred second embodiments, further comprising disposing the ESP downhole in a well (e.g. after attaching the pothead to the ESP motor) and operating the ESP to pump fluid to the surface and/or from the well.

A one hundred fourth embodiment can include the method of the one hundred third embodiment, wherein operating the ESP comprises providing power to the ESP from the surface through the pothead (e.g. electrically connecting and/or powering the stator and/or rotor to a power surface source for operation of the motor; and/or using the ESP assembly to pump fluid uphole (e.g. towards the surface) (e.g. producing the well).

A one hundred fifth embodiment can include the method of any one of the sixth-fourth to the one hundred fourth embodiments, further comprising removing the ESP from the wellbore (e.g. retrieving the ESP from the well), disconnecting the pothead from the ESP motor, disconnecting the pin-socket connections (e.g. unscrewing the nut from the sleeve, uncoupling the socket from the pin, and unscrewing the sleeve from the pin or socket of the pothead), and/or re-using the sleeves for another pin-socket connection.

While embodiments have been shown and described, modifications thereof can be made by one skilled in the art without departing from the spirit and teachings of this disclosure. The embodiments described herein are exemplary only and are not intended to be limiting. Many variations and modifications of the embodiments disclosed herein are possible and are within the scope of this disclosure. For example, the various elements or components may be combined or integrated in another system or certain features may be omitted or not implemented. Also, techniques, systems, subsystems, and methods described and illustrated in the various embodiments as discrete or separate may be combined or integrated with other techniques, systems, subsystems, or methods without departing from the scope of this disclosure. Other items shown or discussed as directly coupled or connected or communicating with each other may be indirectly coupled, connected, or communicated with. Method or process steps set forth may be performed in a different order. The use of terms, such as “first,” “second,” “third” or “fourth” to describe various processes or structures is only used as a shorthand reference to such steps/structures and does not necessarily imply that such steps/structures are performed/formed in that ordered sequence (unless such requirement is clearly stated explicitly in the specification).

Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Language of degree used herein, such as “approximately,” “about,” “generally,” and “substantially,” represent a value, amount, or characteristic close to the stated value, amount, or characteristic that still performs a desired function or achieves a desired result. For example, the language of degree may mean a range of values as understood by a person of skill or, otherwise, an amount that is +/−10%.

Use of broader terms such as comprises, includes, having, etc. should be understood to provide support for narrower terms such as consisting of, consisting essentially of, comprised substantially of, etc. When a feature is described as “optional,” both embodiments with this feature and embodiments without this feature are disclosed. Similarly, the present disclosure contemplates embodiments where this “optional” feature is required and embodiments where this feature is specifically excluded. The use of the terms such as “high-pressure” and “low-pressure” is intended to only be descriptive of the component and their position within the systems disclosed herein. That is, the use of such terms should not be understood to imply that there is a specific operating pressure or pressure rating for such components. For example, the term “high-pressure” describing a manifold should be understood to refer to a manifold that receives pressurized fluid that has been discharged from a pump irrespective of the actual pressure of the fluid as it leaves the pump or enters the manifold. Similarly, the term “low-pressure” describing a manifold should be understood to refer to a manifold that receives fluid and supplies that fluid to the suction side of the pump irrespective of the actual pressure of the fluid within the low-pressure manifold.

Accordingly, the scope of protection is not limited by the description set out above but is only limited by the claims which follow, that scope including all equivalents of the subject matter of the claims. Each and every claim is incorporated into the specification as embodiments of the present disclosure. Thus, the claims are a further description and are an addition to the embodiments of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any element from the set {A, B, C} or any combination thereof, including multiples of any element.

As used herein, the term “and/or” includes any combination of the elements associated with the “and/or” term. Thus, the phrase “A, B, and/or C” includes any of A alone, B alone, C alone, A and B together, B and C together, A and C together, or A, B, and C together.

What is claimed is:

1. An electrical connection system for an ESP configured for downhole use in a well, comprising:
a pothead;
a plurality of motor lead-out wires electrically coupled to the ESP; and
an insulating sleeve corresponding to each motor lead-out wire;
wherein:
each motor lead-out wire is electrically coupled to a connecting socket;
the pothead comprises a pin corresponding to each socket, wherein each corresponding pin-socket connection is configured for electrical coupling when engaged;
each pin comprises a base and threads located externally in proximity to the base of the pin;
an insulating nut is disposed on each motor lead-out wire, wherein the nut comprises threads;
each insulating sleeve comprises a first end configured to receive the corresponding pin, and a second end configured to receive the corresponding socket;
the second end of each insulating sleeve comprises distal internal threads corresponding to the threads of the corresponding nut; and
the insulating sleeve further comprises internal pothead-retaining threads corresponding to the threads of the corresponding pin, wherein the internal pothead-retaining threads are spaced from both the first end and the second end.

2. The system of claim 1, wherein a pothead extension portion of the insulating sleeve extends axially away from the internal pothead-retaining threads to the first end; wherein the pothead extension portion is configured to extend into a body of the pothead, beyond the base of the corresponding pin, and to contact a stop mechanism; and wherein a wire connection portion of the insulating sleeve extends axially away from the internal pothead-retaining threads to the second end.

3. The system of claim 1, wherein each insulating nut is free to rotate about the corresponding motor lead-out wire, and each insulating nut is slidable on the corresponding motor lead-out wire.

4. The system of claim 1, wherein the pothead further comprises a stop mechanism configured for contact with the first end of the insulating sleeve and configured to positively locate the first end of the insulating sleeve axially within a body of the pothead.

5. The system of claim 1, wherein a void is formed between each pin-socket connection and the corresponding insulating sleeve, wherein the void is configured to vent between the corresponding insulating nut and the corresponding motor lead-out wire and/or between the threaded connection of the corresponding insulating nut to the second end of the corresponding insulating sleeve.

6. An electrical connection system for an ESP configured for downhole use in a well, comprising:
a pothead;
one or more motor lead-out wires electrically coupled to the ESP; and
an insulating sleeve corresponding to each motor lead-out wire;
wherein:
each motor lead-out wire is electrically coupled to one of a pin or a connecting socket;
the pothead comprises a corresponding other of the socket or pin, wherein each corresponding pin-socket connection is configured for electrical coupling when engaged;
each socket or pin of the pothead comprises threads;
for each motor lead-out wire, a nut is disposed on the corresponding motor lead-out wire, wherein the nut comprises threads;
each insulating sleeve comprises a first end configured to receive one of the socket or pin of the pothead, and a second end configured to receive the corresponding other of the pin or socket;
the second end of each insulating sleeve comprises distal internal threads corresponding to the threads of the corresponding nut; and
each insulating sleeve further comprises internal pothead-retaining threads corresponding to the threads of the corresponding socket or pin of the pothead.

7. The system of claim 6, wherein the internal pothead-retaining threads are spaced from both the first end and the second end of the insulating sleeve, and wherein each nut is insulating.

8. The system of claim 7, wherein:
a pothead extension portion of the sleeve extends axially away from proximity to the internal pothead-retaining threads to the first end;
a wire connection portion of the sleeve extends axially from proximity to the internal pothead-retaining threads to the second end; and
the pothead extension portion is configured to extend into a body of the pothead, beyond a base of the corresponding pin or socket of the pothead, and to contact a stop mechanism.

9. The system of claim 6, wherein:
a void is formed between each pin-socket connection and the corresponding insulating sleeve; and
the void is configured to vent between the corresponding nut and the corresponding motor lead-out wire and/or between the threaded connection of the corresponding nut to the second end of the insulating sleeve.

10. An insulating sleeve for a pin-socket connection of a pothead to a motor lead-out wire of an ESP, comprising:
a hollow elongated body having a first end configured to receive one of the pin or socket of the pothead, and a second end configured to receive an other of the socket or pin of the corresponding motor lead-out wire;
wherein:
the hollow elongated body comprises distal internal threads corresponding to threads of a nut of the corresponding motor lead-out wire, wherein the distal internal threads are disposed in proximity to the second end; and
the hollow elongated body further comprises internal pothead-retaining threads corresponding to threads of the corresponding pin or socket of the pothead, wherein the internal pothead-retaining threads are spaced from both the first end and the second end.

11. The sleeve of claim 10, wherein:
the hollow elongated body comprises a bore therethrough, extending axially from the first end to the second end;
the first end of the bore is configured to receive the corresponding pin or socket of the pothead and the second end of the bore is configured to receive the corresponding socket or pin of the motor lead-out wire; and
the hollow elongated body is configured to span and to effectively insulate the corresponding pin-socket connection.

12. The sleeve of claim 10, wherein:
the internal pothead-retaining threads are disposed between the first and second ends of the hollow elongated body, with a pothead extension portion of the sleeve extending axially away from the internal pothead-retaining threads to the first end;
a wire connection portion of the sleeve extends axially away from the internal pothead-retaining threads to the second end;
the wire connection portion has a substantially constant bore diameter, the pothead extension portion has a substantially constant bore diameter, and the bore diameter of the pothead extension portion differ from the bore diameter of the wire connection portion; and
the pothead extension portion is configured to extend into a body of the pothead, beyond a base of the corresponding pin or socket of the pothead, for contact with a stop mechanism.

13. The sleeve of claim 10, wherein:
the insulating sleeve is configured to be coupled to the corresponding pin or socket of the pothead at the first end, and is configured to be coupled to the nut of the corresponding motor lead-out wire at the second end; and
the first end of the sleeve is configured to contact a stop mechanism of the pothead when threadingly engaged to the corresponding pin or socket of the pothead.

14. A method of installing an ESP for a well, comprising:
providing, at a wellsite, a pothead having a plurality of pins or sockets, each with threads;
providing, at the wellsite, the ESP having a motor with a plurality of motor lead-out wires, each motor lead-out wire having a socket or pin and a corresponding insulating nut, wherein the plurality of motor lead-out wires is equal in number to the plurality of pins or sockets of the pothead;
providing, at the wellsite, a plurality of insulating sleeves, wherein the plurality of insulating sleeves is equal in number to the plurality of motor lead-out-wires;
threading each insulating sleeve onto the corresponding pin or socket of the pothead;
inserting each socket or pin of the corresponding motor lead-out wire into the corresponding insulating sleeve;
electrically coupling the pins or sockets of the pothead with the corresponding socket or pin of the motor lead-out wires, wherein the corresponding pin-socket connection is disposed within the corresponding insulating sleeve; and
threading each insulating nut to the corresponding insulating sleeve.

15. The method of claim 14, wherein threading each insulating sleeve onto the corresponding pin or socket of the pothead, inserting each socket or pin of the corresponding motor lead-out wire into the corresponding insulating sleeve, electrically coupling the pins or sockets of the pothead with the corresponding socket or pin of the motor lead-out wire, and threading each insulating nut to the corresponding insulating sleeve all occur on-site at the wellsite.

16. The method of claim 14, wherein threading each insulating sleeve onto the corresponding pin or socket of the pothead comprises disposing a pothead extension portion of the insulating sleeve within a body of the pothead, wherein the pothead extension portion extends axially into the body of the pothead beyond the corresponding pin or socket.

17. The method of claim 16, wherein threading each insulating sleeve onto the corresponding pin or socket of the pothead comprises threading the insulating sleeve until the insulating sleeve contacts a stop mechanism within the body of the pothead, and wherein threading the insulating sleeve until the insulating sleeve contacts a stop mechanism comprises inserting the pothead extension portion of the sleeve into the body of the pothead until contact with the stop mechanism.

18. The method of claim 14, wherein:
the plurality of motor lead-out wires corresponds to phases of the motor;
the pothead has pins or sockets corresponding to the phases of the motor; and
electrically coupling the pins or sockets of the pothead with the corresponding socket or pin of the motor lead-out wires comprises making-up the pin-socket connections for all phases of the motor, wherein making up the pin-socket connections occurs without the use of insulating tape.

19. The method of claim 14, wherein electrically coupling each socket or pin of the motor lead-out wires with the corresponding pin or socket of the pothead comprises forming a void space within the corresponding insulating sleeve; wherein the method further comprises filling the void space with oil and venting substantially all air from the void space.

20. The method of claim 18, further comprising attaching the pothead to the ESP motor, at the wellsite;
deploying the ESP downhole in the well; and operating the ESP to pump fluid from the well, wherein operating the ESP comprises providing power to the ESP from the surface through the pothead.
